(19) United States
(12) Patent Application Publication
(10) Pub. No.: US 2026/0129490 A1
(43) Pub. Date: May 7, 2026

(54) USER EQUIPMENT INITIATED UPLINK BEAM UPDATES IN WIRELESS COMMUNICATIONS

(71) Applicant: QUALCOMM Incorporated, San Diego, CA (US)

(72) Inventors: Kiran VENUGOPAL, Green Brook, NJ (US); Yan ZHOU, San Diego, CA (US); Yu ZHANG, San Diego, CA (US); Jing SUN, San Diego, CA (US)

(21) Appl. No.: 18/940,685

(22) Filed: Nov. 7, 2024

(51) Int. Cl. H04W 24/10

(52) U.S. Cl. CPC H04W 24/10

(57) ABSTRACT

Methods, systems, and devices for wireless communications are described that provide for user equipment (UE) transmission of a request for an update of an uplink measurement report. The update of the uplink measurement report may provide information related to one or more changed conditions at the UE that impact uplink communications at the UE. The UE may be configured with an event list that triggers the UE to transmit the request for the update of the uplink measurement report. The event list may include beam update events associated with one or more uplink conditions to trigger transmission of the request. The event list also may include beam update events associated with one or more downlink conditions to trigger transmission of the request.

### INTRODUCTION

The following relates to wireless communications, including measurement reports provided by a user equipment in wireless communications.

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A method for wireless communications by a user equipment (UE) is described. The method may include receiving configuration information that indicates a first set of beam update events that include one or more beam update events associated with one or more uplink conditions to trigger a transmission of a request to update a measurement report associated with a channel between the UE and a network entity, where the configuration information further indicates a second set of beam update events that include one or more beam update events associated with one or more downlink conditions to trigger the transmission of the request to update the measurement report and transmitting the request to update the measurement report in accordance with a detected uplink condition that meets the one or more uplink conditions of the first set of beam update events or a detected downlink condition that meets the one or more downlink conditions of the second set of beam update events.

A UE for wireless communications is described. The UE may include one or more memories, and one or more processors coupled with the one or more memories. The one or more processors may configured to cause the UE to receive configuration information that indicates a first set of beam update events that include one or more beam update events associated with one or more uplink conditions to trigger a transmission of a request to update a measurement report associated with a channel between the UE and a network entity, where the configuration information further indicates a second set of beam update events that include one or more beam update events associated with one or more downlink conditions to trigger the transmission of the request to update the measurement report and transmit the request to update the measurement report in accordance with a detected uplink condition that meets the one or more uplink conditions of the first set of beam update events or a detected downlink condition that meets the one or more downlink conditions of the second set of beam update events.

Another UE for wireless communications is described. The UE may include means for receiving configuration information that indicates a first set of beam update events that include one or more beam update events associated with one or more uplink conditions to trigger a transmission of a request to update a measurement report associated with a channel between the UE and a network entity, where the configuration information further indicates a second set of beam update events that include one or more beam update events associated with one or more downlink conditions to trigger the transmission of the request to update the measurement report and means for transmitting the request to update the measurement report in accordance with a detected uplink condition that meets the one or more uplink conditions of the first set of beam update events or a detected downlink condition that meets the one or more downlink conditions of the second set of beam update events.

A non-transitory computer-readable medium storing code for wireless communications is described. The code may include instructions executable by one or more processors to receive configuration information that indicates a first set of beam update events that include one or more beam update events associated with one or more uplink conditions to trigger a transmission of a request to update a measurement report associated with a channel between the UE and a network entity, where the configuration information further indicates a second set of beam update events that include one or more beam update events associated with one or more downlink conditions to trigger the transmission of the request to update the measurement report and transmit the request to update the measurement report in accordance with a detected uplink condition that meets the one or more uplink conditions of the first set of beam update events or a detected downlink condition that meets the one or more downlink conditions of the second set of beam update events.

In some examples of the method, UEs, and non-transitory computer-readable medium described herein, the one or more uplink conditions include one or more of a first uplink metric that is below a threshold value for a first beam used for communication between the UE and the network entity, a second uplink metric of a second beam that exceeds a corresponding uplink metric for the first beam, a third uplink metric of the second beam that exceeds an absolute threshold value associated with the third uplink metric, a predicted metric value of the first beam or the second beam that meets one or more prediction criteria, or a change in an uplink beam pattern.

Some examples of the method, UEs, and non-transitory computer-readable medium described herein may further include operations, features, means, or instructions for transmitting the request to update the measurement report in accordance with the detected uplink condition that meets the one or more uplink conditions and at least a first downlink condition associated with the first beam that meets the one or more downlink conditions.

In some examples of the method, UEs, and non-transitory computer-readable medium described herein, one or more of the first uplink metric, second uplink metric, or third uplink metric include an uplink reference signal received power (RSRP), an uplink signal to interference and noise ratio (SINR), an uplink throughput value, an uplink transmit power, or a maximum permissible exposure (MPE) value.

In some examples of the method, UEs, and non-transitory computer-readable medium described herein, the first set of beam update events include a first subset of beam update events associated with a first transmission-reception point (TRP) or a first component carrier, and a second subset of beam update events associated with a second TRP or a second component carrier.

In some examples of the method, UEs, and non-transitory computer-readable medium described herein, the one or more uplink conditions include a first uplink metric that has a value above or below a first threshold value and the first threshold value is associated with the first uplink metric and a first event of the first set of beam update events, and the first threshold value is based on one or more of an indication provided with the configuration information, a defined threshold value, or a capability of the UE.

Some examples of the method, UEs, and non-transitory computer-readable medium described herein may further include operations, features, means, or instructions for transmitting one or more instances of a scheduling request that indicates the request to update the measurement report and transmitting one or more instances of a random access channel request that indicates the request to update the measurement report in an absence of a response to the one or more instances of the scheduling request, where the scheduling request and the random access channel request is transmitted via different uplink beams.

Some examples of the method, UEs, and non-transitory computer-readable medium described herein may further include operations, features, means, or instructions for transmitting one or more instances of a random access channel request that indicates the request to update the measurement report based on the detected uplink condition being below a threshold value.

In some examples of the method, UEs, and non-transitory computer-readable medium described herein, the request to update the measurement report includes an event indication that indicates a first beam update event of the first set of beam update events associated with the detected uplink condition, or a second beam update event of the second set of beam update events associated with the detected downlink condition.

In some examples of the method, UEs, and non-transitory computer-readable medium described herein, the event indication includes a set of bits, and different bit values of the set of bits indicate different events or combinations of events of the first set of beam update events and the second set of beam update events.

Some examples of the method, UEs, and non-transitory computer-readable medium described herein may further include operations, features, means, or instructions for selecting a first uplink resource for transmission of the request to update the measurement report based on detection of a beam update event of the first set of beam update events, or selecting a second uplink resource for transmission of the request to update the measurement report based on detection of a beam update event of the second set of beam update events.

In some examples of the method, UEs, and non-transitory computer-readable medium described herein, the configuration information further indicates a priority associated with each beam update event of the first set of beam update events and the second set of beam update events.

In some examples of the method, UEs, and non-transitory computer-readable medium described herein, the configuration information indicates separate priority lists for the first set of beam update events and the second set of beam update events.

In some examples of the method, UEs, and non-transitory computer-readable medium described herein, the configuration information indicates a common priority list for beam update events of the first set of beam update events and the second set of beam update events.

Some examples of the method, UEs, and non-transitory computer-readable medium described herein may further include operations, features, means, or instructions for transmitting a set of multiple instances of the request to update the measurement report, a quantity of the set of multiple instances of the request to update the measurement report based on a configured quantity or a prohibit timer that is initiated upon transmission of an instance of the request to update the measurement report, where the quantity of the set of multiple instances of the request to update the measurement report, or a value of the prohibit timer, is based on a priority associated with each beam update event of the first set of beam update events and the second set of beam update events.

Some examples of the method, UEs, and non-transitory computer-readable medium described herein may further include operations, features, means, or instructions for receiving a resource allocation for transmission of an updated measurement report, the resource allocation indicating first resources for an updated uplink measurement report, second resources for an updated downlink measurement report, or joint resources for an updated joint uplink and downlink measurement report.

Some examples of the method, UEs, and non-transitory computer-readable medium described herein may further include operations, features, means, or instructions for transmitting an updated measurement report to the network entity in accordance with the request to update the measurement report, where an uplink resource and format for the updated measurement report is indicated in the configuration information or is based on a beam update event of the first set of beam update events or the second set of beam update events that triggered the request to update the measurement report.

In some examples of the method, UEs, and non-transitory computer-readable medium described herein, the updated measurement report has a format that includes a first field that indicates a metric associated with a measured reference signal, and a second field that indicates whether the metric is an uplink metric or a downlink metric.

A method for wireless communications by a UE is described. The method may include receiving configuration information that indicates a first set of beam update events that include one or more beam update events associated with one or more uplink conditions to trigger a transmission of a request to update a measurement report that includes one or more uplink channel metrics associated with a channel between the UE and a network entity and transmitting the request to update the measurement report in accordance with a detected uplink condition that meets the one or more uplink conditions of the first set of beam update events.

A UE for wireless communications is described. The UE may include one or more memories, and one or more processors coupled with the one or more memories. The one or more processors may be configured to cause the UE to receive configuration information that indicates a first set of beam update events that include one or more beam update events associated with one or more uplink conditions to trigger a transmission of a request to update a measurement report that includes one or more uplink channel metrics associated with a channel between the UE and a network entity and transmit the request to update the measurement report in accordance with a detected uplink condition that meets the one or more uplink conditions of the first set of beam update events.

Another UE for wireless communications is described. The UE may include means for receiving configuration information that indicates a first set of beam update events that include one or more beam update events associated with one or more uplink conditions to trigger a transmission of a request to update a measurement report that includes one or more uplink channel metrics associated with a channel between the UE and a network entity and means for transmitting the request to update the measurement report in accordance with a detected uplink condition that meets the one or more uplink conditions of the first set of beam update events.

A non-transitory computer-readable medium storing code for wireless communications is described. The code may include instructions executable by one or more processors to receive configuration information that indicates a first set of beam update events that include one or more beam update events associated with one or more uplink conditions to trigger a transmission of a request to update a measurement report that includes one or more uplink channel metrics associated with a channel between the UE and a network entity and transmit the request to update the measurement report in accordance with a detected uplink condition that meets the one or more uplink conditions of the first set of beam update events.

In some examples of the method, UEs, and non-transitory computer-readable medium described herein, the one or more uplink conditions are configured separately from one or more downlink conditions associated with one or more downlink channel metrics.

In some examples of the method, UEs, and non-transitory computer-readable medium described herein, the one or more uplink conditions include one or more of a first uplink metric that is below a threshold value for a first beam used for communication between the UE and the network entity, a second uplink metric of a second beam that exceeds a corresponding uplink metric for the first beam, a third uplink metric of the second beam that exceeds an absolute threshold value associated with the third uplink metric, a predicted metric value of the first beam or the second beam that meets one or more prediction criteria, or a change in an uplink beam pattern.

Some examples of the method, UEs, and non-transitory computer-readable medium described herein may further include operations, features, means, or instructions for transmitting one or more instances of a scheduling request that indicates the request to update the measurement report and transmitting one or more instances of a random access channel request that indicates the request to update the measurement report in an absence of a response to the one or more instances of the scheduling request, where the scheduling request and the random access channel request is transmitted via different uplink beams.

Some examples of the method, UEs, and non-transitory computer-readable medium described herein may further include operations, features, means, or instructions for transmitting one or more instances of a random access channel request that indicates the request to update the measurement report based on the detected uplink condition being below a threshold value.

Some examples of the method, UEs, and non-transitory computer-readable medium described herein may further include operations, features, means, or instructions for transmitting an updated measurement report to the network entity in accordance with the request to update the measurement report, where an uplink resource and format for the updated measurement report is indicated in the configuration information or is based on a beam update event of the first set of beam update events that triggered the request to update the measurement report.

A method for wireless communications by a network entity is described. The method may include outputting configuration information that indicates a first set of beam update events that include one or more beam update events associated with one or more uplink conditions to trigger a request from a UE to update a measurement report associated with a communications channel of the UE, and a second set of beam update events that include one or more beam update events associated with one or more downlink conditions to trigger the request to update the measurement report and obtaining the request to update the measurement report that indicates a detected uplink condition at the UE meets the one or more uplink conditions of the first set of beam update events or a detected downlink condition at the UE meets the one or more downlink conditions of the second set of beam update events.

A network entity for wireless communications is described. The network entity may include one or more memories, and one or more processors coupled with the one or more memories. The one or more processors may individually or collectively be configured to cause the network entity to output configuration information that indicates a first set of beam update events that include one or more beam update events associated with one or more uplink conditions to trigger a request from a UE to update a measurement report associated with a communications channel of the UE, and a second set of beam update events that include one or more beam update events associated with one or more downlink conditions to trigger the request to update the measurement report and obtain the request to update the measurement report that indicates a detected uplink condition at the UE meets the one or more uplink conditions of the first set of beam update events or a detected downlink condition at the UE meets the one or more downlink conditions of the second set of beam update events.

Another network entity for wireless communications is described. The network entity may include means for outputting configuration information that indicates a first set of beam update events that include one or more beam update events associated with one or more uplink conditions to trigger a request from a UE to update a measurement report associated with a communications channel of the UE, and a second set of beam update events that include one or more beam update events associated with one or more downlink conditions to trigger the request to update the measurement report and means for obtaining the request to update the measurement report that indicates a detected uplink condition at the UE meets the one or more uplink conditions of the first set of beam update events or a detected downlink condition at the UE meets the one or more downlink conditions of the second set of beam update events.

A non-transitory computer-readable medium storing code for wireless communications is described. The code may include instructions executable by one or more processors to output configuration information that indicates a first set of beam update events that include one or more beam update events associated with one or more uplink conditions to trigger a request from a UE to update a measurement report associated with a communications channel of the UE, and a second set of beam update events that include one or more beam update events associated with one or more downlink conditions to trigger the request to update the measurement report and obtain the request to update the measurement report that indicates a detected uplink condition at the UE meets the one or more uplink conditions of the first set of beam update events or a detected downlink condition at the UE meets the one or more downlink conditions of the second set of beam update events.

In some examples of the method, network entities, and non-transitory computer-readable medium described herein, the one or more uplink conditions include one or more of a first uplink metric that is below a threshold value for a first beam used for communication between the UE and the network entity, a second uplink metric of a second beam that exceeds a corresponding uplink metric for the first beam, a third uplink metric of the second beam that exceeds an absolute threshold value associated with the third uplink metric, a predicted metric value of the first beam or the second beam that exceeds one or more threshold values, or a change in an uplink beam pattern.

In some examples of the method, network entities, and non-transitory computer-readable medium described herein, the request to update the measurement report indicates that the detected uplink condition meets the one or more uplink conditions and at least a first downlink condition associated with the first beam meets the one or more downlink conditions.

In some examples of the method, network entities, and non-transitory computer-readable medium described herein, one or more of the first uplink metric, second uplink metric, or third uplink metric include an uplink reference signal received power (RSRP), an uplink signal to interference and noise ratio (SINR), or an uplink throughput value, an uplink transmit power, or a maximum permissible exposure (MPE) value.

In some examples of the method, network entities, and non-transitory computer-readable medium described herein, the first set of beam update events include a first subset of beam update events associated with a first transmission-reception point (TRP) or a first component carrier, and a second subset of beam update events associated with a second TRP or a second component carrier.

In some examples of the method, network entities, and non-transitory computer-readable medium described herein, the one or more uplink conditions include a first uplink metric that has a value above or below a first threshold value and the first threshold value is associated with the first uplink metric and a first event of the first set of beam update events, and the first threshold value is based on one or more of an indication provided with the configuration information, a defined threshold value, or a capability of the UE.

In some examples of the method, network entities, and non-transitory computer-readable medium described herein, the configuration information indicates that one or more instances of a scheduling request that includes the request to update the measurement report is to be transmitted, followed by transmission of one or more instances of a random access channel request that indicates the request to update the measurement report in an absence of a response to the one or more instances of the scheduling request and the scheduling request and the random access channel request use different uplink beams.

In some examples of the method, network entities, and non-transitory computer-readable medium described herein, the request to update the measurement report includes an event indication that indicates a first beam update event of the first set of beam update events associated with the detected uplink condition, or a second beam update event of the second set of beam update events associated with the detected downlink condition.

In some examples of the method, network entities, and non-transitory computer-readable medium described herein, the event indication includes a set of bits, and different bit values of the set of bits indicate different events or combinations of events of the first set of beam update events and the second set of beam update events.

In some examples of the method, network entities, and non-transitory computer-readable medium described herein, an uplink resource used for transmission of the request to update the measurement report indicates which of the first set of beam update events or the second set of beam update events is detected at the UE.

In some examples of the method, network entities, and non-transitory computer-readable medium described herein, the configuration information further indicates a priority associated with each beam update event of the first set of beam update events and the second set of beam update events.

In some examples of the method, network entities, and non-transitory computer-readable medium described herein, the configuration information indicates separate priority lists for the first set of beam update events and the second set of beam update events.

In some examples of the method, network entities, and non-transitory computer-readable medium described herein, the configuration information indicates a common priority list for beam update events of the first set of beam update events and the second set of beam update events.

In some examples of the method, network entities, and non-transitory computer-readable medium described herein, the configuration information indicates a quantity of instances of the request to update the measurement report that is to be transmitted, or a prohibit timer value for a prohibit timer that is initiated upon transmission of an instance of the request to update the measurement report and the quantity of the instances of the request to update the measurement report, or the prohibit timer value, is based on a priority associated with each beam update event of the first set of beam update events and the second set of beam update events.

Some examples of the method, network entities, and non-transitory computer-readable medium described herein may further include operations, features, means, or instructions for outputting a resource allocation for uplink transmission of an updated measurement report, the resource allocation indicating first resources for an updated uplink measurement report, second resources for an updated downlink measurement report, or joint resources for an updated joint uplink and downlink measurement report.

Some examples of the method, network entities, and non-transitory computer-readable medium described herein may further include operations, features, means, or instructions for obtaining an updated measurement report in accordance with the request to update the measurement report, where an uplink resource and format for the updated measurement report is indicated in the configuration information or is based on a beam update event of the first set of beam update events or the second set of beam update events that triggered the request to update the measurement report.

In some examples of the method, network entities, and non-transitory computer-readable medium described herein, the updated measurement report has a format that includes a first field that indicates a metric associated with a measured reference signal, and a second field that indicates whether the metric is an uplink metric or a downlink metric.

A method for wireless communications by a network entity is described. The method may include outputting configuration information that indicates a first set of beam update events that include one or more beam update events associated with one or more uplink conditions at a UE to trigger a transmission by the UE of a request to update a measurement report that includes one or more uplink channel metrics associated with a communications channel of the UE and obtaining the request to update the measurement report that indicates a detected uplink condition at the UE meets the one or more uplink conditions of the first set of beam update events.

A network entity for wireless communications is described. The network entity may include one or more memories, and one or more processors coupled with the one or more memories. The one or more processors may be configured to cause the network entity to output configuration information that indicates a first set of beam update events that include one or more beam update events associated with one or more uplink conditions at a UE to trigger a transmission by the UE of a request to update a measurement report that includes one or more uplink channel metrics associated with a communications channel of the UE and obtain the request to update the measurement report that indicates a detected uplink condition at the UE meets the one or more uplink conditions of the first set of beam update events.

Another network entity for wireless communications is described. The network entity may include means for outputting configuration information that indicates a first set of beam update events that include one or more beam update events associated with one or more uplink conditions at a UE to trigger a transmission by the UE of a request to update a measurement report that includes one or more uplink channel metrics associated with a communications channel of the UE and means for obtaining the request to update the measurement report that indicates a detected uplink condition at the UE meets the one or more uplink conditions of the first set of beam update events.

A non-transitory computer-readable medium storing code for wireless communications is described. The code may include instructions executable by one or more processors to output configuration information that indicates a first set of beam update events that include one or more beam update events associated with one or more uplink conditions at a UE to trigger a transmission by the UE of a request to update a measurement report that includes one or more uplink channel metrics associated with a communications channel of the UE and obtain the request to update the measurement report that indicates a detected uplink condition at the UE meets the one or more uplink conditions of the first set of beam update events.

In some examples of the method, network entities, and non-transitory computer-readable medium described herein, the one or more uplink conditions are configured separately from one or more downlink conditions associated with one or more downlink channel metrics.

In some examples of the method, network entities, and non-transitory computer-readable medium described herein, the one or more uplink conditions include one or more of a first uplink metric that is below a threshold value for a first beam used for communication between the UE and the network entity, a second uplink metric of a second beam that exceeds a corresponding uplink metric for the first beam, a third uplink metric of the second beam that exceeds an absolute threshold value associated with the third uplink metric, a predicted metric value of the first beam or the second beam that meets one or more prediction criteria, or a change in an uplink beam pattern.

In some examples of the method, network entities, and non-transitory computer-readable medium described herein, the configuration information indicates that one or more instances of a scheduling request that includes the request to update the measurement report is to be transmitted, followed by transmission of one or more instances of a random access channel request that indicates the request to update the measurement report in an absence of a response to the one or more instances of the scheduling request and the scheduling request and the random access channel request use different uplink beams.

Some examples of the method, network entities, and non-transitory computer-readable medium described herein may further include operations, features, means, or instructions for obtaining an updated measurement report from the UE in accordance with the request to update the measurement report, where an uplink resource and format for the updated measurement report is indicated in the configuration information or is based on a beam update event of the first set of beam update events that triggered the request to update the measurement report.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports user equipment initiated uplink beam updates in wireless communications in accordance with one or more aspects of the present disclosure.

FIG. 2 shows an example of a network architecture that supports user equipment initiated uplink beam updates in wireless communications in accordance with one or more aspects of the present disclosure.

FIG. 3 shows an example of a wireless communications system that supports user equipment initiated uplink beam updates in wireless communications in accordance with one or more aspects of the present disclosure.

FIG. 4 shows an example of a wireless communications system that supports user equipment initiated uplink beam updates in wireless communications in accordance with one or more aspects of the present disclosure.

FIG. 5 shows an example of a timing diagram for update requests that supports user equipment initiated uplink beam updates in wireless communications in accordance with one or more aspects of the present disclosure.

FIG. 6 shows an example of a process flow that supports user equipment initiated uplink beam updates in wireless communications in accordance with one or more aspects of the present disclosure.

FIGS. 7 and 8 show block diagrams of devices that support user equipment initiated uplink beam updates in wireless communications in accordance with one or more aspects of the present disclosure.

FIG. 9 shows a block diagram of a communications manager that supports user equipment initiated uplink beam updates in wireless communications in accordance with one or more aspects of the present disclosure.

FIG. 10 shows a diagram of a system including a device that supports user equipment initiated uplink beam updates in wireless communications in accordance with one or more aspects of the present disclosure.

FIGS. 11 and 12 show block diagrams of devices that support user equipment initiated uplink beam updates in wireless communications in accordance with one or more aspects of the present disclosure.

FIG. 13 shows a block diagram of a communications manager that supports user equipment initiated uplink beam updates in wireless communications in accordance with one or more aspects of the present disclosure.

FIG. 14 shows a diagram of a system including a device that supports user equipment initiated uplink beam updates in wireless communications in accordance with one or more aspects of the present disclosure.

FIGS. 15 through 22 show flowcharts illustrating methods that support user equipment initiated uplink beam updates in wireless communications in accordance with one or more aspects of the present disclosure.

### DETAILED DESCRIPTION

In some wireless communications systems, a user equipment (UE) may provide one or more measurement reports that indicate channel conditions or measurements for signals (such as reference signals) that are received at the UE. In some cases, the measurement reports may contain one or more downlink metrics for multiple measured beams, and a network entity may select a beam for use in communications with the UE based on the reported downlink metrics. For example, a network entity (such as a base station, radio head, or transmission-reception point (TRP)) may transmit multiple reference signals using directional transmissions along multiple associated spatial paths between the network entity and the UE, which may be referred to as beams, and the UE may provide metrics associated with multiple beams in the one or more measurement reports. The network entity may select one of the beams based on the one or more measurement reports, such as by selecting a beam that has a favorable channel condition for communications, and the selected beam may be used for subsequent downlink transmissions to the UE. Further, reciprocal beamforming parameters associated with the selected beam may be used for a reciprocal uplink beam for transmissions from the UE to the network entity.

However, in some scenarios the uplink beam that corresponds to the selected downlink beam may not be as favorable for uplink communications as other uplink beams, even though the downlink beam may have favorable channel conditions for downlink communications. For example, a UE may report two downlink reference signal beams, where a first downlink beam has a higher reference signal received power (RSRP) than a second downlink beam. In some cases, a corresponding first uplink beam that is a reciprocal beam of the first downlink beam may not be as favorable as a second uplink beam that is a reciprocal beam of the second downlink beam. Such a scenario may occur, for example, if the UE performs a power backoff for one or more antenna elements associated with the first uplink beam which is not performed for the second uplink beam, such as due to maximum permissible exposure (MPE) limits. In some wireless communications systems, UEs may provide uplink beam reports in addition to downlink beam reports, which may allow a network entity to account for conditions associated with uplink communications in beam selection. However, such uplink beam reports are transmitted in accordance with a periodic schedule or in response to a trigger from a network entity. In some scenarios, more dynamic uplink reporting to the network entity may allow for lower latency for adjustments to communications parameters due to changes that may affect communications. For example, a changed quantity of available antenna elements at the UE may impact a metric of an uplink beam, a changed uplink beam pattern due to UE device management (such as thermal management, etc.) may impact a metric of an uplink beam, or an uplink power backoff due to MPE conditions may impact a metric of an uplink beam. Existing uplink beam reporting does not provide a mechanism for dynamic uplink reporting based on changed conditions at a UE.

In accordance with various aspects, techniques for requesting and providing updated measurement reports based on changed conditions at a UE are provided. In one example, a UE may transmit a request for an update of an uplink measurement report to provide information related to one or more changed conditions at the UE that impact uplink communications from the UE to a network entity. In some aspects, a UE may be configured with an event list that triggers the UE to transmit a request for an update of an uplink measurement report to provide information related to one or more changed conditions at the UE. The event list may include a first set of beam update events associated with one or more uplink conditions to trigger transmission of the request to update the beam report. The one or more uplink conditions may include, for example, a metric of a current beam (such as a reference signal received power (RSRP)) that is below a threshold value, a metric of a new beam that is better than the corresponding metric of the current beam, a metric of the new beam that is above a threshold value, predicted metrics that meet one or more associated threshold values, a changed uplink beam pattern, or any combination thereof. The event list also may include a second set of beam update events associated with one or more downlink conditions to trigger transmission of the request to update the measurement report, where the downlink conditions are configured separately from the uplink conditions. In some aspects, the request to update the measurement report may be transmitted using a scheduling request (SR) or a physical random access channel (PRACH) transmission. In some aspects, the UE may attempt one or more SRs on a current beam, and switch to a PRACH transmission on a different beam if a response is not received for the one or more SRs. In some aspects, uplink resources used to transmit the request may depend on the events being reported. In some aspects, different priorities may be associated with different events, and the UE may transmit the request and indication of an event based on a higher priority event when multiple events occur concurrently.

The network entity may receive the request, and may trigger an uplink beam report transmission. In some aspects, the UE may transmit a capability indication to the network entity that indicates a UE capability to request an updated measurement report, and the network entity may configure the event list with beam update events. In some aspects, for uplink channel estimation, the UE may measure a downlink reference signal and apply an offset to estimate an associated uplink metric, may use assistance information provided by the network entity, or may derive an uplink metric based on an estimated pathloss of a channel and a configured uplink transmit power.

Particular aspects of the subject matter described in this disclosure may be implemented to improve the operation of the communication devices, and provide enhanced uplink communication reliability and data rates. For example, operations performed by the described communication devices may provide improvements to uplink beam selection by reporting of changed uplink conditions at a transmitting device that are used to select a favorable uplink beam. In some implementations, the operations performed by the described communication devices to provide uplink beam reports based on changed conditions may reduce a time duration for updating uplink communications parameters to account for the changed conditions, thereby reducing the probability of a communications failure for uplink communications. In some other implementations, operations performed by the described communication devices may also support improvements to power consumption, reliability for uplink communications, spectral efficiency, higher data rates and, in some examples, low latency for uplink communications, among other improvements.

Aspects of the disclosure are initially described in the context of wireless communications systems. Aspects of the disclosure are further illustrated by and described with reference to process flows, apparatus diagrams, system diagrams, and flowcharts that relate to UE uplink beam reporting in wireless communications.

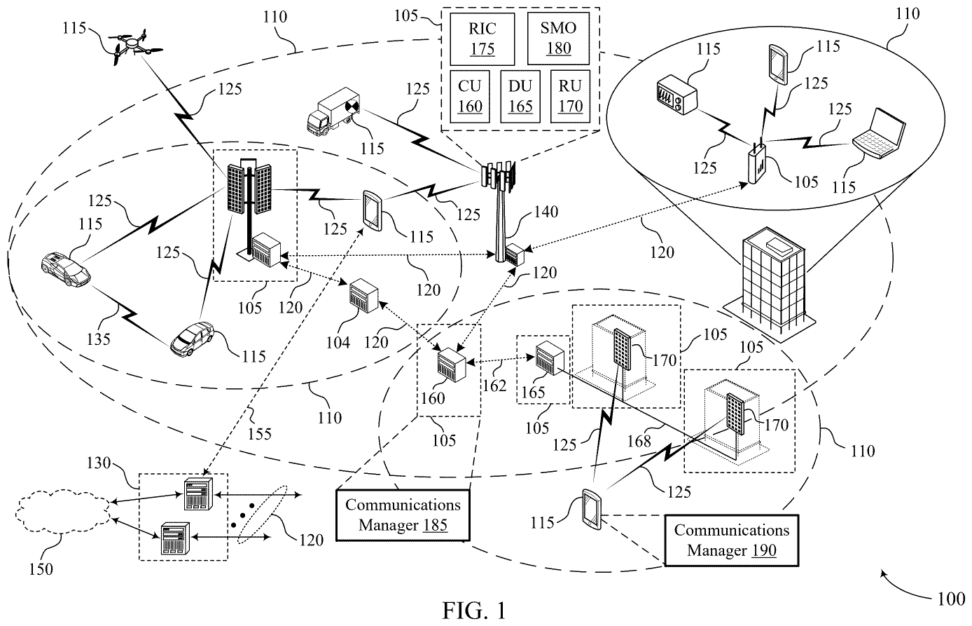

FIG. 1 shows an example of a wireless communications system 100 that supports user equipment initiated uplink beam updates in wireless communications in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs). The network entities 105 may each include a communications manager 185 that is configured to facilitate or otherwise perform wireless communications.

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1. The UEs 115 may each include a communications manager 190 that is configured to facilitate or otherwise perform wireless communications.

As described herein, a node, which may be referred to as a node, a network node, a network entity, or a wireless node, may be a base station (e.g., any base station described herein), a UE (e.g., any UE described herein), a network controller, an apparatus, a device, a computing system, one or more components, and/or another suitable processing entity configured to perform any of the techniques described herein. For example, a network node may be a UE. As another example, a network node may be a base station. As another example, a first network node may be configured to communicate with a second network node or a third network node. In one aspect of this example, the first network node may be a UE, the second network node may be a base station, and the third network node may be a UE. In another aspect of this example, the first network node may be a UE, the second network node may be a base station, and the third network node may be a base station. In yet other aspects of this example, the first, second, and third network nodes may be different relative to these examples. Similarly, reference to a UE, base station, apparatus, device, computing system, or the like may include disclosure of the UE, base station, apparatus, device, computing system, or the like being a network node. For example, disclosure that a UE is configured to receive information from a base station also discloses that a first network node is configured to receive information from a second network node. Consistent with this disclosure, once a specific example is broadened in accordance with this disclosure (e.g., a UE is configured to receive information from a base station also discloses that a first network node is configured to receive information from a second network node), the broader example of the narrower example may be interpreted in the reverse, but in a broad open-ended way. In the example above where a UE being configured to receive information from a base station also discloses that a first network node being configured to receive information from a second network node, the first network node may refer to a first UE, a first base station, a first apparatus, a first device, a first computing system, a first one or more components, a first processing entity, or the like configured to receive the information; and the second network node may refer to a second UE, a second base station, a second apparatus, a second device, a second computing system, a second one or more components, a second processing entity, or the like.

As described herein, communication of information (e.g., any information, signal, or the like) may be described in various aspects using different terminology. Disclosure of one communication term includes disclosure of other communication terms. For example, a first network node may be described as being configured to transmit information to a second network node. In this example and consistent with this disclosure, disclosure that the first network node is configured to transmit information to the second network node includes disclosure that the first network node is configured to provide, send, output, communicate, or transmit information to the second network node. Similarly, in this example and consistent with this disclosure, disclosure that the first network node is configured to transmit information to the second network node includes disclosure that the second network node is configured to receive, obtain, or decode the information that is provided, sent, output, communicated, or transmitted by the first network node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

For instance, an access network (AN) or RAN may include communications between access nodes (e.g., an IAB donor), IAB node(s) 104, and one or more UEs 115. The IAB donor may facilitate connection between the core network 130 and the AN (e.g., via a wired or wireless connection to the core network 130). That is, an IAB donor may refer to a RAN node with a wired or wireless connection to the core network 130. The IAB donor may include one or more of a CU 160, a DU 165, and an RU 170, in which case the CU 160 may communicate with the core network 130 via an interface (e.g., a backhaul link). The IAB donor and IAB node(s) 104 may communicate via an F1 interface according to a protocol that defines signaling messages (e.g., an F1 AP protocol). Additionally, or alternatively, the CU 160 may communicate with the core network 130 via an interface, which may be an example of a portion of a backhaul link, and may communicate with other CUs (e.g., including a CU 160 associated with an alternative IAB donor) via an Xn-C interface, which may be an example of another portion of a backhaul link.

IAB node(s) 104 may refer to RAN nodes that provide IAB functionality (e.g., access for UEs 115, wireless self-backhauling capabilities). A DU 165 may act as a distributed scheduling node towards child nodes associated with the IAB node(s) 104, and the IAB-MT may act as a scheduled node towards parent nodes associated with IAB node(s) 104. That is, an IAB donor may be referred to as a parent node in communication with one or more child nodes (e.g., an IAB donor may relay transmissions for UEs through other IAB node(s) 104). Additionally, or alternatively, IAB node(s) 104 may also be referred to as parent nodes or child nodes to other IAB node(s) 104, depending on the relay chain or configuration of the AN. The IAB-MT entity of IAB node(s) 104 may provide a Uu interface for a child IAB node (e.g., the IAB node(s) 104) to receive signaling from a parent IAB node (e.g., the IAB node(s) 104), and a DU interface (e.g., a DU 165) may provide a Uu interface for a parent IAB node to signal to a child IAB node or UE 115.

For example, IAB node(s) 104 may be referred to as parent nodes that support communications for child IAB nodes, or may be referred to as child IAB nodes associated with IAB donors, or both. An IAB donor may include a CU 160 with a wired or wireless connection (e.g., backhaul communication link(s) 120) to the core network 130 and may act as a parent node to IAB node(s) 104. For example, the DU 165 of an IAB donor may relay transmissions to UEs 115 through IAB node(s) 104, or may directly signal transmissions to a UE 115, or both. The CU 160 of the IAB donor may signal communication link establishment via an F1 interface to IAB node(s) 104, and the IAB node(s) 104 may schedule transmissions (e.g., transmissions to the UEs 115 relayed from the IAB donor) through one or more DUs (e.g., DUs 165). That is, data may be relayed to and from IAB node(s) 104 via signaling via an NR Uu interface to MT of IAB node(s) 104 (e.g., other IAB node(s)). Communications with IAB node(s) 104 may be scheduled by a DU 165 of the IAB donor or of IAB node(s) 104.

In the case of the techniques described herein applied in the context of a disaggregated RAN architecture, one or more components of the disaggregated RAN architecture may be configured to support reconfiguration of C-DRX upon deactivation of LP-WUSs as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

In some examples, such as in a carrier aggregation configuration, a carrier may have acquisition signaling or control signaling that coordinate operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different RAT).

The communication link(s) 125 of the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular RAT (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

The electromagnetic spectrum is often subdivided, based on frequency/wavelength, into various classes, bands, channels, etc. In 5G NR two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “millimeter wave” or the like if used herein may broadly represent frequencies that may include mid-band frequencies, may be within FR2, FR4, FR4-a or FR4-1, and/or FR5, or may be within the EHF band.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID)). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a network entity 105 operating with lower power (e.g., a base station 140 operating with lower power) relative to a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or more cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

Some UEs 115, such as MTC or IoT devices, may be relatively low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 may include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by a transmitting device (e.g., a network entity 105 or a UE 115) along a single beam direction (e.g., a direction associated with the receiving device, such as another network entity 105 or UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a transmitting device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., the communication link(s) 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in relatively poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

Techniques described herein, in addition to or as an alternative to be carried out between UEs 115 and network entities 105, may be implemented via additional or alternative wireless devices, including IAB nodes 104, distributed units (DUs) 165, centralized units (CUs) 160, radio units (RUs) 170, and the like. For example, in some implementations, aspects described herein may be implemented in the context of a disaggregated radio access network (RAN) architecture (e.g., open RAN architecture). In a disaggregated architecture, the RAN may be split into three areas of functionality corresponding to the CU 160, the DU 165, and the RU 170. The split of functionality between the CU 160, DU 165, and RU 170 is flexible and as such gives rise to numerous permutations of different functionalities depending upon which functions (e.g., MAC functions, baseband functions, radio frequency functions, and any combinations thereof) are performed at the CU 160, DU 165, and RU 170. For example, a functional split of the protocol stack may be employed between a DU 165 and an RU 170 such that the DU 165 may support one or more layers of the protocol stack and the RU 170 may support one or more different layers of the protocol stack.

Some wireless communications systems (e.g., wireless communications system 100), infrastructure and spectral resources for NR access may additionally support wireless backhaul link capabilities in supplement to wireline backhaul connections, providing an IAB network architecture. One or more network entities 105 (e.g., base stations) may include CUs 160, DUs 165, and RUs 170 and may be referred to as donor network entities 105, donor base stations, or IAB donors. One or more DUs 165 (e.g., and/or RUs 170) associated with a donor network entity 105 (e.g., donor base station) may be partially controlled by CUs 160 associated with the donor network entity 105. The one or more donor network entities 105 (e.g., donor base stations, IAB donors) may be in communication with one or more additional network entities 105 (e.g., IAB nodes 104) via supported access and backhaul links. IAB nodes 104 may support mobile terminal (MT) functionality controlled and/or scheduled by DUs 165 of a coupled IAB donor. In addition, the IAB nodes 104 may include DUs 165 that support communication links with additional entities (e.g., IAB nodes 104, UEs 115, etc.) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

In some examples, the wireless communications system 100 may include a core network 130 (e.g., a next generation core network (NGC)), one or more IAB donors, IAB nodes 104, and UEs 115, where IAB nodes 104 may be partially controlled by each other and/or the IAB donor. The IAB donor and IAB nodes 104 may be examples of aspects of network entities 105. IAB donor and one or more IAB nodes 104 may be configured as (e.g., or in communication according to) some relay chain.

For instance, an access network (AN) or RAN may refer to communications between access nodes (e.g., IAB donor), IAB nodes 104, and one or more UEs 115. The IAB donor may facilitate connection between the core network 130 and the AN (e.g., via a wireline or wireless connection to the core network 130). That is, an IAB donor may refer to a RAN node with a wireline or wireless connection to core network 130.

The IAB donor may include a CU 160 and at least one DU 165 (e.g., and RU 170), where the CU 160 may communicate with the core network 130 over an NG interface (e.g., some backhaul link). The CU 160 may host layer 3 (L3) (e.g., RRC, service data adaption protocol (SDAP), PDCP, etc.) functionality and signaling. The at least one DU 165 and/or RU 170 may host lower layer, such as layer 1 (L1) and layer 2 (L2) (e.g., RLC, MAC, physical (PHY), etc.) functionality and signaling, and may each be at least partially controlled by the CU 160. The DU 165 may support one or multiple different cells. IAB donor and IAB nodes 104 may communicate over an F1 interface according to some protocol that defines signaling messages (e.g., F1 AP protocol). Additionally, CU 160 may communicate with the core network over an NG interface (which may be an example of a portion of backhaul link), and may communicate with other CUs 160 (e.g., a CU 160 associated with an alternative IAB donor) over an Xn-C interface (which may be an example of a portion of a backhaul link).

IAB nodes 104 may refer to a RAN node that provides IAB functionality (e.g., access for UEs 115, wireless self-backhauling capabilities, etc.). IAB nodes 104 may include a DU 165 and an MT. A DU 165 may act as a distributed scheduling node towards child nodes associated with the IAB node 104, and the MT may act as a scheduled node towards parent nodes associated with the IAB node 104. That is, an IAB donor may be referred to as a parent node in communication with one or more child nodes (e.g., an IAB donor may relay transmissions for UEs through one or more other IAB nodes 104). Additionally, an IAB node 104 may also be referred to as a parent node or a child node to other IAB nodes 104, depending on the relay chain or configuration of the AN. Therefore, the MT entity of IAB nodes 104 (e.g., MTs) may provide a Uu interface for a child node to receive signaling from a parent IAB node 104, and the DU interface (e.g., DUs 165) may provide a Uu interface for a parent node to signal to a child IAB node 104 or UE 115.

For example, IAB node 104 may be referred to a parent node associated with IAB node, and a child node associated with IAB donor. The IAB donor may include a CU 160 with a wireline (e.g., optical fiber) or wireless connection to the core network and may act as parent node to IAB nodes 104. For example, the DU 165 of IAB donor may relay transmissions to UEs 115 through IAB nodes 104, and may directly signal transmissions to a UE 115. The CU 160 of IAB donor may signal communication link establishment via an F1 interface to IAB nodes 104, and the IAB nodes 104 may schedule transmissions (e.g., transmissions to the UEs 115 relayed from the IAB donor) through the DUs 165. That is, data may be relayed to and from IAB nodes 104 via signaling over an NR Uu interface to MT of the IAB node 104. Communications with IAB node 104 may be scheduled by DU 165 of IAB donor and communications with IAB node 104 may be scheduled by DU 165 of IAB node 104.

In the case of the techniques described herein applied in the context of a disaggregated RAN architecture, one or more components of the disaggregated RAN architecture (e.g., one or more IAB nodes 104 or components of IAB nodes 104) may be configured to support techniques for large round trip times in random access channel procedures as described herein. For example, some operations described as being performed by a UE 115 or a network entity 105 may additionally, or alternatively, be performed by components of the disaggregated RAN architecture (e.g., IAB nodes, DUs, CUs, etc.).

In some aspects, the respective wireless devices of the wireless communications system 100 (e.g., UEs 115, network entities 105, IoT devices, IAB nodes, etc.) may support signaling and configurations for transmission of measurement reports, or beam reports, that indicate measurements of downlink reference signals, which may be used for beam selection for subsequent communications. In some implementations, in addition to measurements associated with downlink reference signals, one or more beam reports may include one or more parameters associated with uplink beams from a UE 115. In some aspects, one or more UEs 115 may detect a changed condition associated with uplink communications, and may transmit a request for an update of a beam report to provide one or more uplink parameters. In some implementations, such a UE 115 may detect one or more changed conditions, such as due to a changed uplink beam pattern or uplink power backoff, and may request to update an uplink beam report or both an uplink and downlink beam report. In some aspects, a UE 115 may be configured with an event list that triggers the UE 115 to transmit a request for an update of an uplink or downlink measurement report, or both, to provide information related to one or more changed conditions at the UE 115. In some aspects, the request to update the measurement report may be transmitted using a SR or PRACH transmission. In some aspects, the UE 115 may attempt one or more SRs on a current beam, and switch to a PRACH transmission on a different beam if a response is not received for the one or more SRs. A network entity 105 may receive the request, and may trigger an measurement report transmission for an uplink measurement report, downlink measurement report, or both. In some aspects, the UE 115 may transmit a capability indication to the network entity 105 that indicates a UE 115 capability to request an updated measurement report, and the network entity 105 may configure the event list with beam update events in accordance with the UE 115 capability.

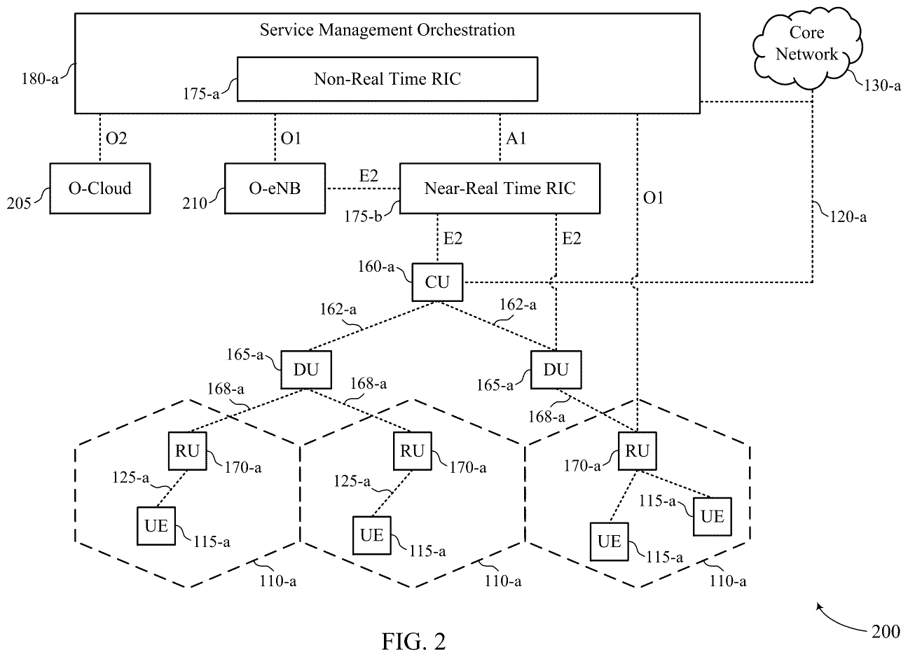

FIG. 2 shows an example of a network architecture 200 (e.g., a disaggregated base station architecture, a disaggregated RAN architecture) that supports user equipment initiated uplink beam updates in wireless communications in accordance with one or more aspects of the present disclosure. The network architecture 200 may illustrate an example for implementing one or more aspects of the wireless communications system 100. The network architecture 200 may include one or more CUs 160-a that may communicate directly with a core network 130-a via a backhaul communication link 120-a, or indirectly with the core network 130-a through one or more disaggregated network entities 105 (e.g., a Near-RT RIC 175-b via an E2 link, or a Non-RT RIC 175-a associated with an SMO 180-a (e.g., an SMO Framework), or both). A CU 160-a may communicate with one or more DUs 165-a via respective midhaul communication links 162-a (e.g., an F1 interface). The DUs 165-a may communicate with one or more RUs 170-a via respective fronthaul communication links 168-a. The RUs 170-a may be associated with respective coverage areas 110-a and may communicate with UEs 115-a via one or more communication links 125-a. In some implementations, a UE 115-a may be simultaneously served by multiple RUs 170-a.

Each of the network entities 105 of the network architecture 200 (e.g., CUs 160-a, DUs 165-a, RUs 170-a, Non-RT RICs 175-a, Near-RT RICs 175-b, SMOs 180-a, Open Clouds (O-Clouds) 205, Open eNBs (O-eNBs) 210) may include one or more interfaces or may be coupled with one or more interfaces configured to receive or transmit signals (e.g., data, information) via a wired or wireless transmission medium.

Each network entity 105, or an associated processor (e.g., controller) providing instructions to an interface of the network entity 105, may be configured to communicate with one or more of the other network entities 105 via the transmission medium. For example, the network entities 105 may include a wired interface configured to receive or transmit signals over a wired transmission medium to one or more of the other network entities 105. Additionally, or alternatively, the network entities 105 may include a wireless interface, which may include a receiver, a transmitter, or transceiver (e.g., an RF transceiver) configured to receive or transmit signals, or both, over a wireless transmission medium to one or more of the other network entities 105.

In some examples, a CU 160-a may host one or more higher layer control functions. Such control functions may include RRC, PDCP, SDAP, or the like. Each control function may be implemented with an interface configured to communicate signals with other control functions hosted by the CU 160-a. A CU 160-a may be configured to handle user plane functionality (e.g., CU-UP), control plane functionality (e.g., CU-CP), or a combination thereof. In some examples, a CU 160-a may be logically split into one or more CU-UP units and one or more CU-CP units. A CU-UP unit may communicate bidirectionally with the CU-CP unit via an interface, such as an E1 interface when implemented in an O-RAN configuration. A CU 160-a may be implemented to communicate with a DU 165-a, as necessary, for network control and signaling.

A DU 165-a may correspond to a logical unit that includes one or more functions (e.g., base station functions, RAN functions) to control the operation of one or more RUs 170-a. In some examples, a DU 165-a may host, at least partially, one or more of an RLC layer, a MAC layer, and one or more aspects of a PHY layer (e.g., a high PHY layer, such as modules for FEC encoding and decoding, scrambling, modulation and demodulation, or the like) depending, at least in part, on a functional split, such as those defined by the 3rd Generation Partnership Project (3GPP). In some examples, a DU 165-a may further host one or more low PHY layers. Each layer may be implemented with an interface configured to communicate signals with other layers hosted by the DU 165-a, or with control functions hosted by a CU 160-a.

In some examples, lower-layer functionality may be implemented by one or more RUs 170-a. For example, an RU 170-a, controlled by a DU 165-a, may correspond to a logical node that hosts RF processing functions, or low-PHY layer functions (e.g., performing fast Fourier transform (FFT), inverse FFT (iFFT), digital beamforming, physical random access channel (PRACH) extraction and filtering, or the like), or both, based at least in part on the functional split, such as a lower-layer functional split. In such an architecture, an RU 170-a may be implemented to handle over the air (OTA) communication with one or more UEs 115-a. In some implementations, real-time and non-real-time aspects of control and user plane communication with the RU(s) 170-a may be controlled by the corresponding DU 165-a. In some examples, such a configuration may enable a DU 165-a and a CU 160-a to be implemented in a cloud-based RAN architecture, such as a vRAN architecture.

The SMO 180-a may be configured to support RAN deployment and provisioning of non-virtualized and virtualized network entities 105. For non-virtualized network entities 105, the SMO 180-a may be configured to support the deployment of dedicated physical resources for RAN coverage requirements which may be managed via an operations and maintenance interface (e.g., an O1 interface). For virtualized network entities 105, the SMO 180-a may be configured to interact with a cloud computing platform (e.g., an O-Cloud 205) to perform network entity life cycle management (e.g., to instantiate virtualized network entities 105) via a cloud computing platform interface (e.g., an O2 interface). Such virtualized network entities 105 can include, but are not limited to, CUs 160-a, DUs 165-a, RUs 170-a, and Near-RT RICs 175-b. In some implementations, the SMO 180-a may communicate with components configured in accordance with a 4G RAN (e.g., via an O1 interface). Additionally, or alternatively, in some implementations, the SMO 180-a may communicate directly with one or more RUs 170-a via an O1 interface. The SMO 180-a also may include a Non-RT RIC 175-a configured to support functionality of the SMO 180-a.

The Non-RT RIC 175-a may be configured to include a logical function that enables non-real-time control and optimization of RAN elements and resources, Artificial Intelligence (AI) or Machine Learning (ML) workflows including model training and updates, or policy-based guidance of applications/features in the Near-RT RIC 175-b. The Non-RT RIC 175-a may be coupled to or communicate with (e.g., via an A1 interface) the Near-RT RIC 175-b. The Near-RT RIC 175-b may be configured to include a logical function that enables near-real-time control and optimization of RAN elements and resources via data collection and actions over an interface (e.g., via an E2 interface) connecting one or more CUs 160-a, one or more DUs 165-a, or both, as well as an O-eNB 210, with the Near-RT RIC 175-b.

In some examples, to generate AI/ML models to be deployed in the Near-RT RIC 175-b, the Non-RT RIC 175-a may receive parameters or external enrichment information from external servers. Such information may be utilized by the Near-RT RIC 175-b and may be received at the SMO 180-a or the Non-RT RIC 175-a from non-network data sources or from network functions. In some examples, the Non-RT RIC 175-a or the Near-RT RIC 175-b may be configured to tune RAN behavior or performance. For example, the Non-RT RIC 175-a may monitor long-term trends and patterns for performance and employ AI or ML models to perform corrective actions through the SMO 180-a (e.g., reconfiguration via O1) or via generation of RAN management policies (e.g., A1 policies).

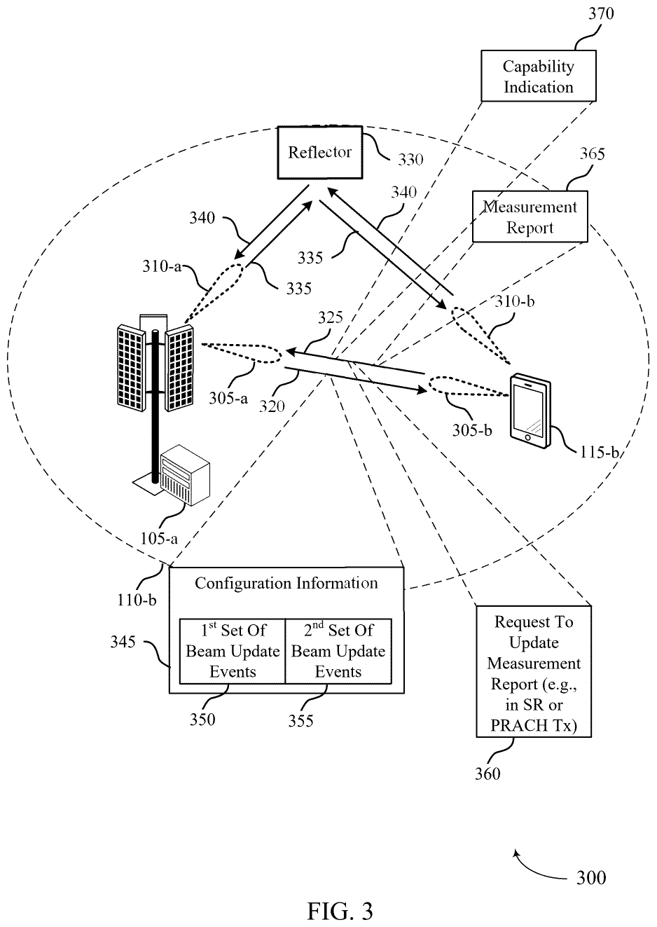

FIG. 3 shows an example of a wireless communications system 300 that supports user equipment initiated uplink beam updates in wireless communications in accordance with one or more aspects of the present disclosure. In some examples, aspects of the wireless communications system 300 may implement, or be implemented by, aspects of the wireless communications system 100, the network architecture 200, or both. The wireless communications system 300 may include a UE 115-b, and a network entity 105-a with coverage area 110-b, which may be examples of a UE 115 and a network entity 105, as described with reference to FIGS. 1 and 2.

In the wireless communications system 300 of FIG. 3, the UE 115-b and the network entity 105-a may have multiple beams available for communications, including a first beam 305 (e.g., including a first downlink beam 305-a that corresponds to a first uplink beam 305-b) that corresponds to a line of sight path between the UE 115-b and the network entity 105-a and that supports a first downlink communication link 320 and a first uplink communication link 325. The multiple beams also may include a second beam 310 (including a second downlink beam 310-a that corresponds to a second uplink beam 310-b) that corresponds to a non-line-of-sight path via a reflector 330, and that supports a second downlink communication link 335 and a second uplink communication link 340. The UE 115-b may measure one or more parameters associated with each beam, and in some examples may measure a first RSRP associated with the first downlink communication link 320 that is higher than a second RSRP associated with the second downlink communication link 335. The UE 115-b may provide a measurement report that indicates the measured RSRP values, and the network entity 105-a may select the first beam 305, and the first downlink communication link 320 and the first uplink communication link 325, for communications between the network entity 105-a and the UE 115-b.

As discussed herein, in some aspects the UE 115-b also may provide one or more uplink parameters in a measurement report 365, such as an uplink measurement report that is separate from a downlink measurement report, or a combined measurement report that includes both downlink and uplink parameters. In some aspects, the UE 115-b may determine that one or more uplink parameters have changed since a prior measurement report that provides uplink parameters. For example, an MPE change at the UE 115-b may result in a lower available uplink transmit power for the first uplink communication link 325, but not for the second uplink communication link 340 (such as due to different antennas associated with the different links). In some aspects, the network entity 105-a may configure the UE 115-b with configuration information 345 that includes beam update events (e.g., a first set of beam update events 350 for uplink beams, and a second set of beam update events 355 for downlink beams) that may trigger a request 360 to update measurement report 365. In some aspects, the UE 115-b may request to update an uplink beam report or both an uplink and downlink beam report. The request 360 to update the measurement report 365 may be transmitted, in some aspects, using a SR or a PRACH transmission. In some aspects, the UE 115-b may transmit one or more SRs that include the request 360 to update the measurement report 365, and if a response is not received, transmit one or more PRACH transmissions that include the request 360 to update the measurement report 365. The PRACH transmissions may use a different beam than the SRs. The network entity 105-a may receive the request 360, and may trigger an uplink beam report transmission. The UE 115-b may transmit an updated measurement report 365 with one or more uplink parameters, which may be used by the network entity 105-a to select a same or a different beam for uplink and/or downlink communications. In some implementations, the UE 115-b may measure downlink reference signals on each of the first downlink communication link 320 and the second downlink communication link 335, which may correspond to two narrow channel state information (CSI) reference signal beams that are quasi-co-located (QCLed) with a same SSB beam or two different SSB beams.

In some aspects, the UE 115-b may transmit a capability indication 370 to the network entity 105-a that indicates a UE 115-b capability to request an updated uplink beam report, and the network entity 105-a may configure, such as by RRC signaling, the UE 115-b with one or more sets of beam update events, and to transmit the request and associated uplink beam report. In some aspects, the capability indication 370 from the UE 115-b may indicate a capability to the network entity 105-a that indicates a UE 115-b capability to request an updated uplink measurement report and an updated downlink measurement report, which may be indicated in separate capability indications or in a common capability that is applicable for both uplink and downlink beam measurement reports. In aspects where the UE 115-b indicates a capability to request updated uplink and downlink measurement reports, the one or more sets of beam update events may include separate sets of beam events for triggering requests to update uplink and downlink measurement reports, or a set of beam update events may include both uplink and downlink events.

As discussed herein, in some aspects the UE 115-b may transmit a request 360 to provide an updated uplink measurement report. Such a request 360 may be transmitted based on one or more conditions that are present at the UE 115-b, and the network entity 105-a may not be aware of such conditions at the UE 115-b. In some aspects, the network entity 105-a may configure the UE 115-b with a set of beam update events that may trigger a request for an updated measurement report. In some aspects, one or more parameters included in the uplink beam report may be determined by the UE 115-b based on one or more downlink reference signal measurements. In some implementations, for an uplink RSRP estimation, the UE 115-b may use a downlink reference signal measurement corresponding to the first downlink beam 305-a to first get the downlink RSRP and then derive an associated uplink RSRP for the first uplink beam 305-b. In some implementations, the downlink reference signal may be a QCLed reference signal in the TCI of the first uplink beam 305-b. Similar parameters may be determined for the second beam 310. In some aspects, the network entity 105-a may provide assistance information that may be used by the UE 115-b to estimate one or more uplink parameters. For example, the UE 115-b may derive an uplink RSRP based on an uplink configured transmit power minus a measured downlink RSRP, plus an offset value provided as assistance information by the network entity 105-a (that is, UL RSRP=UL configured Tx Power−DL RSRP+offset). The offset may be configured by the network entity 105-a to compensate for a higher downlink transmit power relative to an uplink transmit power. In some implementations, the UE 115-b may estimate a pathloss and derive an uplink RSRP based on the pathloss. For example, a pathloss reference signal (such as a CSI reference signal) corresponding to an uplink reference signal may be used to estimate a downlink pathloss, and the downlink pathloss may be used to derive the uplink RSRP (that is, UL RSRP=UL configured Tx Power−pathloss). In some implementations, the measurement report 365 from the UE 115-b may include downlink metrics, such as downlink RSRP for the same reference signal, or a different set of downlink reference signals configured for a downlink report.

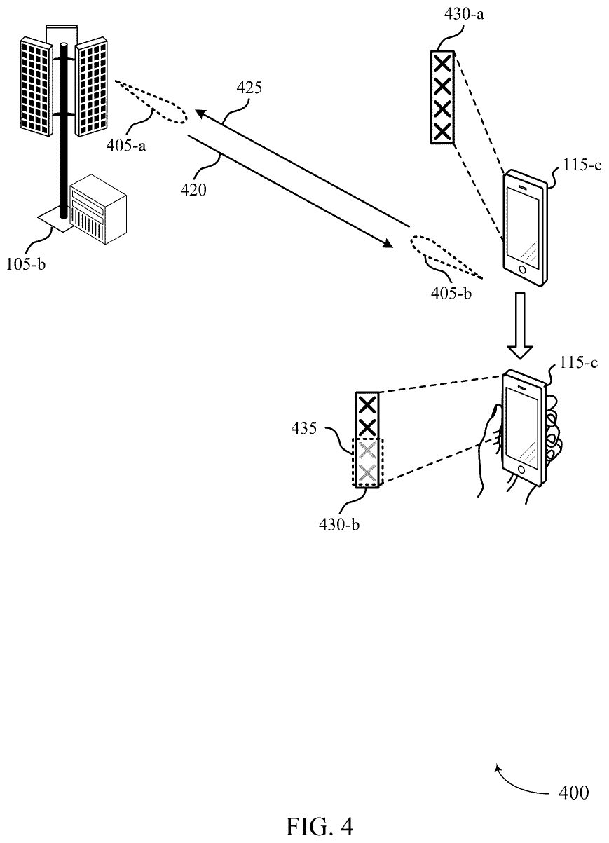

FIG. 4 shows an example of a wireless communications system 400 that supports user equipment initiated uplink beam updates in wireless communications in accordance with one or more aspects of the present disclosure. In some examples, aspects of the wireless communications system 400 may implement, or be implemented by, aspects of the wireless communications system 100, the network architecture 200, the wireless communications system 300, or any combination thereof. The wireless communications system 400 may include a UE 115-c, and a network entity 105-b, which may be examples of UEs and network entities as described with reference to FIGS. 1 through 3.

In the wireless communications system 400 of FIG. 4, the UE 115-c and the network entity 105-b may have multiple beams available for communications, including a first beam 405 (such as first downlink beam 405-a and first uplink beam 405-b) as illustrated in FIG. 4 that supports a first downlink communication link 420 and a first uplink communication link 425. In this example, an initial condition shown as UE 115-c-a may provide that a set of antennas 430-a of the UE 115-c has all available antenna elements usable for communications. The UE 115-c may have transmitted an uplink beam report based on the initial state, that indicates uplink beam parameters associated with the initial state of UE 115-c and the set of antennas 430-a. Subsequent to the initial condition, a user may place their hand such that one or more of the antenna elements (e.g., antenna elements 435) may not be usable for communications, where the set of antennas 430-b include fewer available antenna elements. In some implementations, based on a detection of the new condition, the UE 115-c may transmit a request for an updated uplink beam report, in order to provide updated uplink beam parameters associated with updated state of UE 115-c and the set of antennas 430-b with fewer available antenna elements. The network entity 105-b may receive the request, and provide an indication of resources for the updated beam report, receive the updated beam report, and select an uplink and/or downlink beam based on the updated beam report, as discussed herein.

In accordance with various aspects, the network entity 105-b may configure the UE 115-c with one or more sets of events that trigger a request to update a measurement report. In some aspects, a set of events may be configured for triggering an update to an uplink measurement report. For example, for a UE 115-c initiated uplink beam reporting update, some example sets of events may include:

### Example 1

Event1: An uplink metric of a current uplink beam is below a configured first threshold value;
Event2: An uplink metric of a new beam exceeds a configured second threshold value; or
Event3: The current uplink beam pattern changed.

### Example 2

Event1: An uplink metric (e.g., RSRP) of a current uplink beam is below a configured threshold.
Event2: An uplink metric of at least one new beam is at least a threshold value above the uplink metric of the current beam (e.g., a new beam has a metric that exceeds a corresponding metric of the current beam by the threshold value);
Event3: An uplink metric of a new beam exceeds a configured threshold value (e.g., a new beam has a metric that exceeds an absolute threshold value);
Event4: A combination of Event1 and Event3;
Event5: A predicted value of an uplink metric for the current or a new beam satisfies a condition. For example, a predicted value (e.g., instead of a measured value) for the current beam or a new beam may satisfy a condition (e.g., a defined condition or a configured condition. In some examples, the condition may be associated with a duration, a prediction confidence level, or both.
Event6: The current uplink beam pattern changed. For example, a beam pattern change that leads to a reduction in a supported uplink/downlink rank by a certain threshold amount (e.g., which may allow the network entity 105-b to save some energy or hypothesis tests to rule out some ranks); and
Event7+: Any of events 1-6 in combination with a measured downlink metric (e.g., downlink RSRP), such as:
   Event 7-1: A relatively small change for downlink RSRP of the current beam (e.g., within a certain threshold relative to a prior measured value), and an uplink metric of a new beam exceeds an associated threshold value (for example, which may initiate a change from a current joint downlink/uplink beam to separate beams that include the current downlink beam and a new uplink beam); or
   Event 7-2: A downlink RSRP of a current beam is below a first threshold value and an uplink metric of current beam is better than a second threshold value.

### Example 3

Event1: an Uplink Metric (e.g., Rsrp) of a Current Uplink Beam Is Below a configured threshold;
Event2: An uplink metric of at least one new beam is at least a threshold value above the uplink metric of the current beam (e.g., a new beam has a metric that exceeds a corresponding metric of the current beam by the threshold value);
Event3: An uplink metric of a new beam exceeds a configured threshold value (e.g., a new beam has a metric that exceeds an absolute threshold value);
Event4: A combination of Event1 and Event3;
Event5: A predicted value of an uplink metric for the current uplink beam is below a configured threshold;
Event6: A predicted value of an uplink metric for a new beam is at least a threshold value above the predicted uplink metric of the current beam (e.g., a new beam has a predicted metric that exceeds a corresponding metric of the current beam by the threshold value);
Event7: A predicted value of an uplink metric for a new beam exceeds a configured threshold value (e.g., a new beam has a predicted metric that exceeds an absolute threshold value);
Event8: A combination of Event5 and Event7;
Event9: The current uplink beam pattern changed;
Event10+: Any of events 1-9 in combination with a measured downlink metric (e.g., downlink RSRP), such as:
   Event 10-1: A relatively small change for downlink RSRP of the current beam, and an uplink metric of a new beam exceeds an associated threshold value; or
   Event 10-2: A downlink RSRP of a current beam is below a first threshold value and an uplink metric of current beam is better than a second threshold value.

Corresponding sets of events may be configured for UE 115-c initiated downlink beam report update requests, with one or more downlink metrics. The various threshold values associated with different events of one or more sets of events may apply to a specific set of events, or one or more of the threshold values may apply to multiple different sets of events. It is noted that the example sets of events are provided for purposes of illustration and discussion, and numerous other examples of sets of events may be implemented in accordance with various aspects of the disclosure.

Various sets of events may have more or fewer events than in the above examples, may be based on one or more different metrics, may be based on one or more different threshold values associated with one or more different metrics, or any combination thereof.

In some aspects, the uplink metric may be an uplink transmit power, a beam or cell MPE, an estimated uplink RSRP, an uplink SINR, an uplink throughput, or any combination thereof. In some aspects, the UE 115-c may determine the uplink metric based on additional assistance information from the network entity 105-b. In some aspects, one or multiple threshold values may be provided for one or more events of the set of events, and the threshold values may be event specific, metric specific, or both. In some aspects, the threshold values may be configured (e.g., via RRC signaling), based on a UE 115-c capability, defined in a standard, or any combination thereof. Additionally, or alternatively, events may be TRP specific and/or carrier specific. For example, each event per TRP or carrier may be assigned or identified with a separate event ID.

In some aspects, as part of the request for the UE 115-c initiated measurement report update, the UE 115-c may provide an indication related to the event that triggered the uplink beam report update. In some aspects, a bitword-event combination or mapping may be configured, or defined in a standard, and the UE 115-c request may include the bitword. Using the configuration, the network entity 105-b may dynamically restrict reporting or prioritize a subset of events among the defined events. In some aspects, additionally, or alternatively, depending on the event definition or configuration, different uplink resources may be used by the UE 115-c to send the indication. For example, Events 1, 3, 4, 7 may be indicated via two bits in a physical uplink control channel (PUCCH) transmission that includes the request for the updated measurement report, while events 2, 5, 6 may be included in physical uplink shared channel (PUSCH) multiplexed bits, Events 8, 9 may be indicated via a PRACH transmission with dedicated preamble (contention free random access (CFRA)), and Events 10, 12 may be indicated via a contention based random access (CBRA) transmission. In some aspects, uplink resources for each event may be either configured via signaling (e.g., RRC signaling, a MAC control element, or downlink control information (DCI)), or defined in a standard. In some aspects, for high priority events or depending on an application or scenario, multiple uplink resource types may be assigned for a same event.

In some aspects, a priority may be defined for one or more events. Such a priority may be useful if multiple event conditions are met within a short interval or concurrently (e.g., if multiple event conditions are at least partially overlapping in time), or if channel state information (CSI) part dropping is configured and a CSI report has both downlink and uplink metrics. In some aspects, for a UE 115-c capable of UE-initiated uplink measurement reporting updates, priority may be defined for at least one of the requests and the associated report based on a separate priority list among uplink events and downlink events (e.g., a set of downlink events that may trigger a measurement report update). In some aspects, if a cell or beam is both uplink and downlink, priority may be determined based on a downlink event or report having higher priority, an uplink event or report having higher priority, or a joint uplink and downlink measurement report having higher priority. In some aspects, if a cell is both uplink and downlink, priority for the request is based on a defined priority for uplink or downlink (or joint) requests, and priority for the associated measurement report may be determined based on an indication from the network entity 105-b in response to the request (e.g., in a DCI or CSI grant). In some aspects, if a cell is uplink-only, priority for the request may be specified as discussed above. In some aspects, if a cell is configured as 6G only cell, a 6G request and reporting may have higher priority. In some further aspects, a common priority list may be provided, that includes of both uplink and downlink events, and a higher priority event is indicated and/or reported earlier than a lower priority event if they occur concurrently. In some aspects, the common priority list may be separately defined or configured in addition to existing priorities among uplink resources, which may be useful when different uplink resources are associated with different events. Within a respective priority list, priority may be based on event ID, report config ID, for example. In some aspects, the UE 115-c may indicate an event as a bitmap so that multiple events can be indicated by the UE 115-c in a single request. For example, if five events are configured in a set of beam update events, a bitmap of ‘10110’ may indicate events 1, 3, and 4 have been triggered.

In some aspects, some events may be more critical, and in addition to a higher priority, some more signaling or UE 115-c behavior may be provided to efficiently respond to such events. In some aspects, for a UE 115-c capable of UE-initiated uplink beam reporting updates, a number of retransmissions for a UE 115-c request or prohibit time (or both) before which the UE 115-c may retransmit a request may be configured or specified as a function of event priority. For example, Event 1 may be configured with up to N retransmissions for enhanced likelihood of successful reception of the request, with at least k slots between each transmission, where N and k (or both) may be specified based on subcarrier spacing (SCS), frequency range (FR), radio access technology (RAT), and the like. In some cases, the configuration may be specified, or dynamically indicated based on the application or scenario. Such a technique may also be used for UE initiated downlink beam reporting.

In accordance with some aspects, the network entity 105-b may receive the request and allocate resources for an updated measurement report, which may be based on the indicated event or priority specific. In some aspects, the network entity 105-b response to the UE 115-c request can be, when separate requests are received associated with different events or priorities, a trigger or grant of separate uplink beam reporting resources based on a separate DCI, a trigger or grant of separate uplink beam reporting resources based on a single DCI with separate grants (e.g. one for event 1, and another for event 2), or a trigger or grant of a single uplink beam reporting resource based on a single DCI for the UE 115-c to report multiple beam updates via a single grant. In other cases, if a single request is received and indicates simultaneous uplink and downlink beam report updates, the network entity 105-b may trigger or grant separate beam reporting resources based on separate DCI transmissions, may trigger or grant separate beam reporting resources based on a single DCI with two grants (e.g., one for the downlink update, one for the uplink update), or may trigger or grant a single beam reporting resource based on a single DCI for the UE 115-c to report both downlink and uplink reports.

In some aspects, depending on the event or priority, the content of the UE 115-c report may be different, and the resources and format used for uplink beam report update may be specified. In some aspects, the uplink resource and format used for sending a UE-initiated uplink beam report update may be based on the UE 115-c request (e.g., based on event/priority indicated, different UL resources/formats may be predefined, or a default reporting resource/format may be specified to include both downlink and uplink metrics for a same set of measurements of a set of reference signals), a fixed resource allocation determined by the network entity 105-b that specifies the format of the measurement report in the response to the UE 115-c, or separate resources for downlink-only, uplink-only, and downlink-plus-uplink reports may be provided with priority for the report specified. In cases where a fixed resource allocation is provided, the fixed resource allocation may be for an uplink-only report with N reference signals and associated metrics, for an uplink-plus-downlink report with uplink and downlink metrics reported for the same N reference signals, or may be for an uplink and downlink report with downlink metrics reported for N1 reference signals, an uplink metrics reported for N2 reference signals, where the RS may be different between uplink and downlink.

In some aspects, the measurement report transmitted by the UE 115-c may have a report format that is associated with a UE-initiated beam report. The measurement report may have a fixed report format for that may be defined to cover various uplink and downlink event triggered beam updates. In some aspects, the report may include N reference signal IDs and associated N metrics, and an additional two bits, where the value of N may be specified or configured (e.g., provided with the configuration information that configured the one or more sets of events). The metrics may be uplink metrics or downlink metrics, which may be indicated by one of the bits out of the additional 2 bits. For example, a bit value of 0 means a downlink metric, and a bit value of 1 means an uplink metric. In some aspects, a second bit of the additional two bits may indicate if a follow-up report with the other metric that is not included in the current report and associated with a reference signal that is to be reported as well. For example, a bit value of 0 means no follow-up, and a bit value of 1 means follow-up needed.

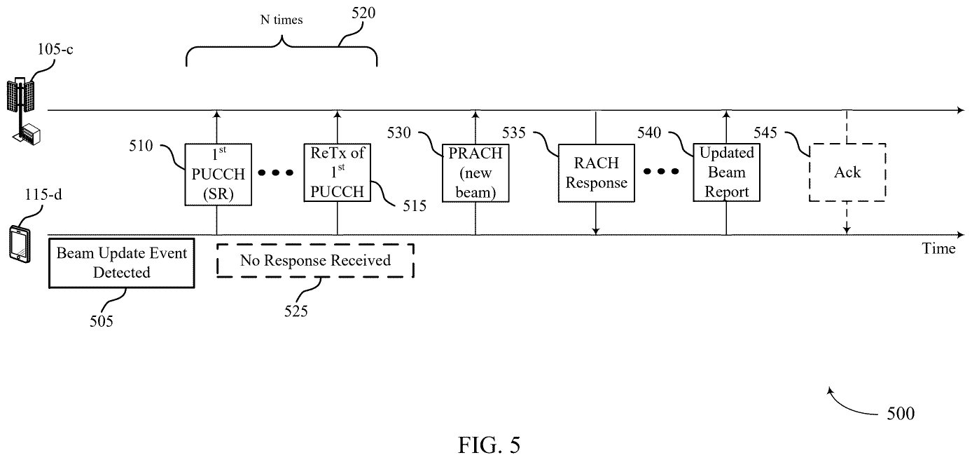

FIG. 5 shows an example of a timing diagram 500 for update requests that supports user equipment initiated uplink beam updates in wireless communications in accordance with one or more aspects of the present disclosure. In some examples, aspects of the timing diagram 500 may implement, or be implemented by, aspects of the wireless communications system 100, the network architecture 200, the wireless communications system 300, the wireless communications system 400, or any combination thereof.

In the example of FIG. 5, a UE 115-d and a network entity 105-c may communicate via an established connection with an uplink beam and a downlink beam. In some aspects, the network entity 105-c may configure the UE 115-d with beam update events that may include a first set of uplink beam events and a second set of downlink beam update events, which may trigger a request from the UE 115-d to update a measurement report, in accordance with various techniques as discussed herein. In some implementations, as part of the request for the UE-initiated uplink measurement report update, the UE 115-d may transmit a SR-type uplink indication up to N times and if no response is received from the network entity 105-c, the UE 115-d may transmit the request via one or more PRACH transmissions on a new beam. For example, the UE 115-d may be in a beam update event detected condition 505, and transmit a first PUCCH 510 that includes a SR or other uplink indication of the request to update the measurement report. The UE 115-d may transmit one or more retransmissions of the first PUCCH 515 with the request, with up to N repetitions 520, where N may be configured at the UE 115-d (e.g., via RRC signaling with the beam update events configuration). In the example of FIG. 5, the UE 115-d may monitor for a response to the PUCCH transmissions with the request, and in the event no response is received 525, the UE 115-d may transmit a PRACH 530 that indicates the request using a different beam than used for the PUCCH transmissions. The UE 115-d may receive a random access channel (RACH) response 535, and may transmit an updated beam report 540. In some implementations, the network entity 105-c may transmit an acknowledgment 545 of the updated beam report 540. In some examples, such as when an event that triggered the beam update event detected condition 505 has a condition of a current beam metric being below a threshold value (e.g., when the UE 115-c has a degraded uplink channel), the first PUCCH 510 transmission and retransmissions of the first PUCCH 515 may use a degraded beam and may have a relatively low likelihood of being successfully received at the network entity 105-c, and the PRACH fallback may enhance the likelihood of successful receipt of the request to update the measurement report. In some aspects, the UE 115-d may directly transmit the PRACH 530 if an event condition is below a threshold value, where the threshold value may be set as a stricter condition (e.g., in comparison with a threshold that triggers the first PUCCH 510 transmission) so that the UE 115-d may avoid a transmission with a low likelihood of success, thereby reducing latency.

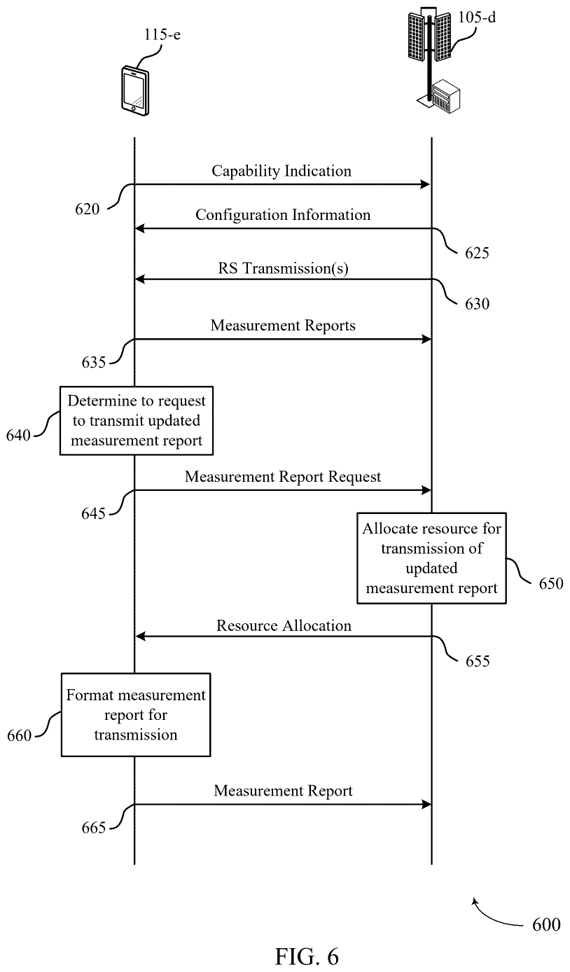

FIG. 6 shows an example of a process flow 600 that supports user equipment initiated uplink beam updates in wireless communications in accordance with one or more aspects of the present disclosure. The process flow 600 may include a network entity 105-d and a UE 115-e, which may be examples of corresponding devices as described with reference to FIGS. 1 through 5. The UE 115-e may perform uplink beam reporting and the UE 115-e and network entity 105-d may perform updates to uplink beam reporting as discussed herein. Such techniques may provide for enhanced communication reliability, reduced latency, and efficient communications, which may thereby enhance overall network efficiency and user experience. In the following description of the process flow 600, the operations between the devices may be performed in a different order than the example order shown. Some operations may be omitted from the process flow 600, and other operations may be added to the process flow 600.

At 620, the UE 115-e may transmit, and the network entity 105-d may receive, a capability indication that indicates a UE 115-e capability to request an updated measurement report. The capability indication may indicate, in some implementations, that the UE 115-e is capable of transmitting a request for an uplink beam report update, is capable of transmitting a request for a downlink beam report update, is capable of transmitting a common request for both an uplink and a downlink beam report, or any combination thereof. In some implementations, the capability indication may indicate additional capabilities, such as a capability to derive uplink metrics based on assistance information from the network entity 105-d or a capability to compute an estimated pathloss for use in deriving an associated uplink parameter, and the network entity 105-d may provide assistance information or a configuration based on the indicated capability.

At 625, the network entity 105-d may transmit, and the UE 115-e may receive, configuration information related to uplink beam report requests and associated resources. In some implementations, the configuration information may be provided via RRC signaling. Additionally, or alternatively, all or a portion of the configuration information may be provided in a medium access control (MAC) control element, or in downlink control information. The configuration information may include beam update events, such as different sets of beam update events for downlink and uplink beams, where the beam update events are associated with channel conditions (e.g., uplink or downlink conditions) to trigger a transmission of a request to update a measurement report.

At 630, the network entity 105-d may transmit, and the UE 115-e may receive, one or more reference signal transmissions. In some implementations, the reference signal transmissions may include CSI reference signal transmissions, synchronization signal block (SSB) transmissions, or other reference signal transmissions (such as pathloss reference signals other downlink reference signals). At 635, the UE 115-e may transmit, and the network entity 105-d may receive, one or more measurement reports. The measurement reports may include, in some implementations, downlink measurement reports, uplink measurement reports, and/or joint uplink and downlink measurement reports.

At 640, the UE 115-e may determine to request to transmit an updated measurement report. The UE 115-e may make the determination based on one or more conditions at the UE 115-e, such as a detected event of the configured beam update events, as discussed herein. At 645, the UE 115-e may transmit, and the network entity 105-d may receive, a measurement report request. In some implementations, as discussed herein, the measurement report request may be a single or multi-bit indication that is provided in UCI (e.g., a SR), in a configured uplink resource, a configured PRACH preamble, or any combination thereof.

At 650, the network entity may allocate a resource for transmission of an updated measurement report. At 655, the network entity 105-d may transmit, and the UE 115-e may receive, a resource allocation for the uplink beam report. In some implementations, the resource allocation may be made based on receipt of the request. In other implementations, the resource allocation may be provided to the UE 115-e along with the configuration information, such as in a configured grant of uplink resources, and the UE 115-e may use one of the configured resources after transmission of the request.

At 660, the UE 115-e may format the uplink measurement report for transmission. The measurement report, as discussed herein, may be an uplink beam report that includes one or more uplink parameters that are measured or derived by the UE 115-e. At 665, the UE 115-e may transmit, and the network entity 105-d may receive, the updated uplink beam report. In some implementations, a downlink measurement report may also be formatted and transmitted, or a joint uplink and downlink measurement report may be formatted and transmitted.

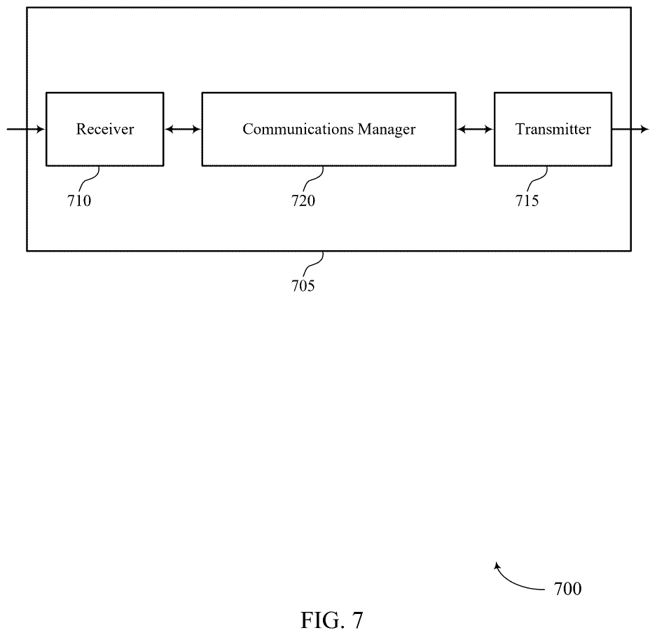

FIG. 7 shows a block diagram 700 of a device 705 that supports user equipment initiated uplink beam updates in wireless communications in accordance with one or more aspects of the present disclosure. The device 705 may be an example of aspects of a UE 115 as described herein. The device 705 may include a receiver 710, a transmitter 715, and a communications manager 720. The device 705, or one or more components of the device 705 (e.g., the receiver 710, the transmitter 715, the communications manager 720), may include at least one processor, which may be coupled with at least one memory, to, individually or collectively, support or enable the described techniques. Each of these components may be in communication with one another (e.g., via one or more buses).

The receiver 710 may provide a means for receiving information such as packets, user data, control information, or any combination thereof associated with various information channels (e.g., control channels, data channels, information channels related to user equipment initiated uplink beam updates in wireless communications). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to user equipment initiated uplink beam updates in wireless communications). In some examples, the transmitter 715 may be co-located with a receiver 710 in a transceiver module. The transmitter 715 may utilize a single antenna or a set of multiple antennas.

The communications manager 720, the receiver 710, the transmitter 715, or various combinations or components thereof may be examples of means for performing various aspects of user equipment initiated uplink beam updates in wireless communications as described herein. For example, the communications manager 720, the receiver 710, the transmitter 715, or various combinations or components thereof may be capable of performing one or more of the functions described herein.

In some examples, the communications manager 720, the receiver 710, the transmitter 715, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 720, the receiver 710, the transmitter 715, or various combinations or components thereof may be implemented in code (e.g., as communications management software or firmware) executed by at least one processor (e.g., referred to as a processor-executable code). If implemented in code executed by at least one processor, the functions of the communications manager 720, the receiver 710, the transmitter 715, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 720 may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communications in accordance with examples as disclosed herein. For example, the communications manager 720 is capable of, configured to, or operable to support a means for receiving configuration information that indicates a first set of beam update events that include one or more beam update events associated with one or more uplink conditions to trigger a transmission of a request to update a measurement report associated with a channel between the UE and a network entity, where the configuration information further indicates a second set of beam update events that include one or more beam update events associated with one or more downlink conditions to trigger the transmission of the request to update the measurement report. The communications manager 720 is capable of, configured to, or operable to support a means for transmitting the request to update the measurement report in accordance with a detected uplink condition that meets the one or more uplink conditions of the first set of beam update events or a detected downlink condition that meets the one or more downlink conditions of the second set of beam update events.

Additionally, or alternatively, the communications manager 720 may support wireless communications in accordance with examples as disclosed herein. For example, the communications manager 720 is capable of, configured to, or operable to support a means for receiving configuration information that indicates a first set of beam update events that include one or more beam update events associated with one or more uplink conditions to trigger a transmission of a request to update a measurement report that includes one or more uplink channel metrics associated with a channel between the UE and a network entity. The communications manager 720 is capable of, configured to, or operable to support a means for transmitting the request to update the measurement report in accordance with a detected uplink condition that meets the one or more uplink conditions of the first set of beam update events.

By including or configuring the communications manager 720 in accordance with examples as described herein, the device 705 (e.g., at least one processor controlling or otherwise coupled with the receiver 710, the transmitter 715, the communications manager 720, or a combination thereof) may support techniques for UE uplink beam reporting as discussed herein, which may enhance communications reliability and provide for reduced latency.

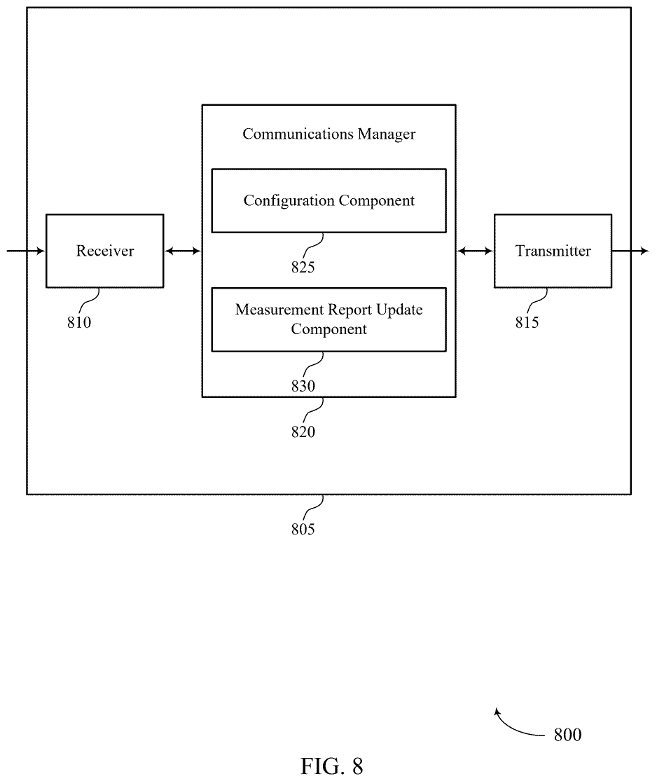

FIG. 8 shows a block diagram 800 of a device 805 that supports user equipment initiated uplink beam updates in wireless communications in accordance with one or more aspects of the present disclosure. The device 805 may be an example of aspects of a device 705 or a UE 115 as described herein. The device 805 may include a receiver 810, a transmitter 815, and a communications manager 820. The device 805, or one of more components of the device 805 (e.g., the receiver 810, the transmitter 815, the communications manager 820), may include at least one processor, which may be coupled with at least one memory, to support the described techniques. Each of these components may be in communication with one another (e.g., via one or more buses).

The receiver 810 may provide a means for receiving information such as packets, user data, control information, or any combination thereof associated with various information channels (e.g., control channels, data channels, information channels related to user equipment initiated uplink beam updates in wireless communications). Information may be passed on to other components of the device 805. The receiver 810 may utilize a single antenna or a set of multiple antennas.

The transmitter 815 may provide a means for transmitting signals generated by other components of the device 805. For example, the transmitter 815 may transmit information such as packets, user data, control information, or any combination thereof associated with various information channels (e.g., control channels, data channels, information channels related to user equipment initiated uplink beam updates in wireless communications). In some examples, the transmitter 815 may be co-located with a receiver 810 in a transceiver module. The transmitter 815 may utilize a single antenna or a set of multiple antennas.

The device 805, or various components thereof, may be an example of means for performing various aspects of user equipment initiated uplink beam updates in wireless communications as described herein. For example, the communications manager 820 may include a configuration component 825 a measurement report update component 830, or any combination thereof. The communications manager 820 may be an example of aspects of a communications manager 720 as described herein. In some examples, the communications manager 820, or various components thereof, may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communications in accordance with examples as disclosed herein. The configuration component 825 is capable of, configured to, or operable to support a means for receiving configuration information that indicates a first set of beam update events that include one or more beam update events associated with one or more uplink conditions to trigger a transmission of a request to update a measurement report associated with a channel between the UE and a network entity, where the configuration information further indicates a second set of beam update events that include one or more beam update events associated with one or more downlink conditions to trigger the transmission of the request to update the measurement report. The measurement report update component 830 is capable of, configured to, or operable to support a means for transmitting the request to update the measurement report in accordance with a detected uplink condition that meets the one or more uplink conditions of the first set of beam update events or a detected downlink condition that meets the one or more downlink conditions of the second set of beam update events.

Additionally, or alternatively, the communications manager 820 may support wireless communications in accordance with examples as disclosed herein. The configuration component 825 is capable of, configured to, or operable to support a means for receiving configuration information that indicates a first set of beam update events that include one or more beam update events associated with one or more uplink conditions to trigger a transmission of a request to update a measurement report that includes one or more uplink channel metrics associated with a channel between the UE and a network entity. The measurement report update component 830 is capable of, configured to, or operable to support a means for transmitting the request to update the measurement report in accordance with a detected uplink condition that meets the one or more uplink conditions of the first set of beam update events.

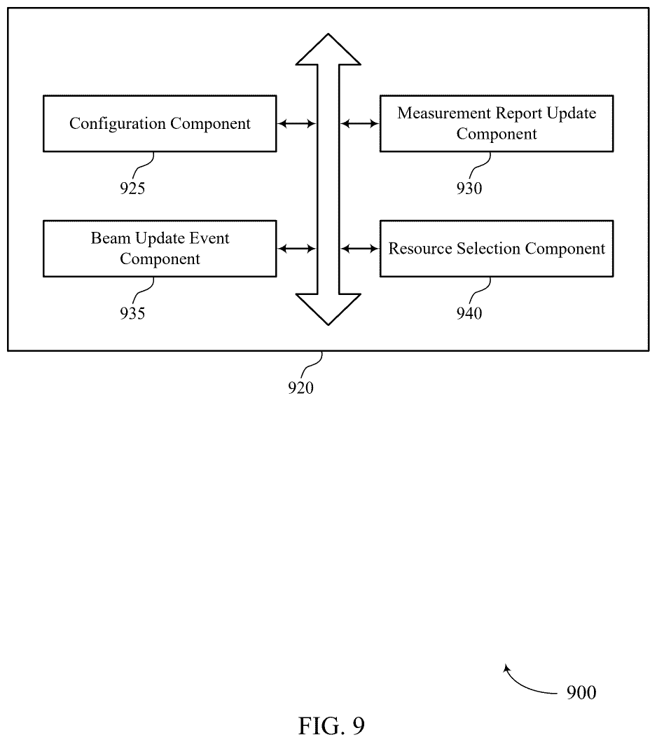

FIG. 9 shows a block diagram 900 of a communications manager 920 that supports user equipment initiated uplink beam updates in wireless communications in accordance with one or more aspects of the present disclosure. The communications manager 920 may be an example of aspects of a communications manager 720, a communications manager 820, or both, as described herein. The communications manager 920, or various components thereof, may be an example of means for performing various aspects of user equipment initiated uplink beam updates in wireless communications as described herein. For example, the communications manager 920 may include a configuration component 925, a measurement report update component 930, a beam update event component 935, a resource selection component 940, or any combination thereof. Each of these components, or components or subcomponents thereof (e.g., one or more processors, one or more memories), may communicate, directly or indirectly, with one another (e.g., via one or more buses).

The communications manager 920 may support wireless communications in accordance with examples as disclosed herein. The configuration component 925 is capable of, configured to, or operable to support a means for receiving configuration information that indicates a first set of beam update events that include one or more beam update events associated with one or more uplink conditions to trigger a transmission of a request to update a measurement report associated with a channel between the UE and a network entity, where the configuration information further indicates a second set of beam update events that include one or more beam update events associated with one or more downlink conditions to trigger the transmission of the request to update the measurement report. The measurement report update component 930 is capable of, configured to, or operable to support a means for transmitting the request to update the measurement report in accordance with a detected uplink condition that meets the one or more uplink conditions of the first set of beam update events or a detected downlink condition that meets the one or more downlink conditions of the second set of beam update events.

In some examples, the one or more uplink conditions include one or more of a first uplink metric that is below a threshold value for a first beam used for communication between the UE and the network entity, a second uplink metric of a second beam that exceeds a corresponding uplink metric for the first beam, a third uplink metric of the second beam that exceeds an absolute threshold value associated with the third uplink metric, a predicted metric value of the first beam or the second beam that meets one or more prediction criteria, or a change in an uplink beam pattern.

In some examples, the measurement report update component 930 is capable of, configured to, or operable to support a means for transmitting the request to update the measurement report in accordance with the detected uplink condition that meets the one or more uplink conditions, at least a first downlink condition associated with the first beam that meets the one or more downlink conditions, or both. In some examples, one or more of the first uplink metric, second uplink metric, or third uplink metric include an uplink reference signal received power (RSRP), an uplink signal to interference and noise ratio (SINR), an uplink throughput value, an uplink transmit power, or a maximum permissible exposure (MPE) value. In some examples, the first set of beam update events include a first subset of beam update events associated with a first transmission-reception point (TRP) or a first component carrier, and a second subset of beam update events associated with a second TRP or a second component carrier.

In some examples, the one or more uplink conditions include a first uplink metric that has a value above or below a first threshold value, and where the first threshold value is associated with the first uplink metric and a first event of the first set of beam update events, and the first threshold value is based on one or more of an indication provided with the configuration information, a defined threshold value, or a capability of the UE.

In some examples, the measurement report update component 930 is capable of, configured to, or operable to support a means for transmitting one or more instances of a scheduling request that indicates the request to update the measurement report. In some examples, the measurement report update component 930 is capable of, configured to, or operable to support a means for transmitting one or more instances of a random access channel request that indicates the request to update the measurement report in an absence of a response to the one or more instances of the scheduling request, where the scheduling request and the random access channel request are transmitted via different uplink beams.

In some examples, the measurement report update component 930 is capable of, configured to, or operable to support a means for transmitting one or more instances of a random access channel request that indicates the request to update the measurement report based on the detected uplink condition being below a threshold value. In some examples, the request to update the measurement report includes an event indication that indicates a first beam update event of the first set of beam update events associated with the detected uplink condition, or a second beam update event of the second set of beam update events associated with the detected downlink condition. In some examples, the event indication includes a set of bits, and different bit values of the set of bits indicate different events or combinations of events of the first set of beam update events and the second set of beam update events.

In some examples, the resource selection component 940 is capable of, configured to, or operable to support a means for selecting a first uplink resource for transmission of the request to update the measurement report based at least in part on detection of a beam update event of the first set of beam update events, or selecting a second uplink resource for transmission of the request to update the measurement report based at least in part on detection of a beam update event of the second set of beam update events. In some examples, the configuration information further indicates a priority associated with each beam update event of the first set of beam update events and the second set of beam update events. In some examples, the configuration information indicates separate priority lists for the first set of beam update events and the second set of beam update events. In some examples, the configuration information indicates a common priority list for beam update events of the first set of beam update events and the second set of beam update events.

In some examples, the measurement report update component 930 is capable of, configured to, or operable to support a means for transmitting a set of multiple instances of the request to update the measurement report, a quantity of the set of multiple instances of the request to update the measurement report based on a configured quantity or a prohibit timer that is initiated upon transmission of an instance of the request to update the measurement report, where the quantity of the set of multiple instances of the request to update the measurement report, or a value of the prohibit timer, is based on a priority associated with each beam update event of the first set of beam update events and the second set of beam update events.

In some examples, the resource selection component 940 is capable of, configured to, or operable to support a means for receiving a resource allocation for transmission of an updated measurement report, the resource allocation indicating first resources for an updated uplink measurement report, second resources for an updated downlink measurement report, or joint resources for an updated joint uplink and downlink measurement report.

In some examples, the measurement report update component 930 is capable of, configured to, or operable to support a means for transmitting an updated measurement report to the network entity in accordance with the request to update the measurement report, where an uplink resource and format for the updated measurement report is indicated in the configuration information or is based on a beam update event of the first set of beam update events or the second set of beam update events that triggered the request to update the measurement report. In some examples, the updated measurement report has a format that includes a first field that indicates a metric associated with a measured reference signal, and a second field that indicates whether the metric is an uplink metric or a downlink metric.

Additionally, or alternatively, the communications manager 920 may support wireless communications in accordance with examples as disclosed herein. In some examples, the configuration component 925 is capable of, configured to, or operable to support a means for receiving configuration information that indicates a first set of beam update events that include one or more beam update events associated with one or more uplink conditions to trigger a transmission of a request to update a measurement report that includes one or more uplink channel metrics associated with a channel between the UE and a network entity. In some examples, the measurement report update component 930 is capable of, configured to, or operable to support a means for transmitting the request to update the measurement report in accordance with a detected uplink condition that meets the one or more uplink conditions of the first set of beam update events. In some examples, the one or more uplink conditions are configured separately from one or more downlink conditions associated with one or more downlink channel metrics. In some examples, the one or more uplink conditions include one or more of a first uplink metric that is below a threshold value for a first beam used for communication between the UE and the network entity, a second uplink metric of a second beam that exceeds a corresponding uplink metric for the first beam, a third uplink metric of the second beam that exceeds an absolute threshold value associated with the third uplink metric, a predicted metric value of the first beam or the second beam that meets one or more prediction criteria, or a change in an uplink beam pattern.

In some examples, the measurement report update component 930 is capable of, configured to, or operable to support a means for transmitting one or more instances of a scheduling request that indicates the request to update the measurement report. In some examples, the measurement report update component 930 is capable of, configured to, or operable to support a means for transmitting one or more instances of a random access channel request that indicates the request to update the measurement report in an absence of a response to the one or more instances of the scheduling request, where the scheduling request and the random access channel request are transmitted via different uplink beams.

In some examples, the measurement report update component 930 is capable of, configured to, or operable to support a means for transmitting one or more instances of a random access channel request that indicates the request to update the measurement report based on the detected uplink condition being below a threshold value.

In some examples, the resource selection component 940 is capable of, configured to, or operable to support a means for transmitting an updated measurement report to the network entity in accordance with the request to update the measurement report, where an uplink resource and format for the updated measurement report is indicated in the configuration information or is based on a beam update event of the first set of beam update events that triggered the request to update the measurement report.

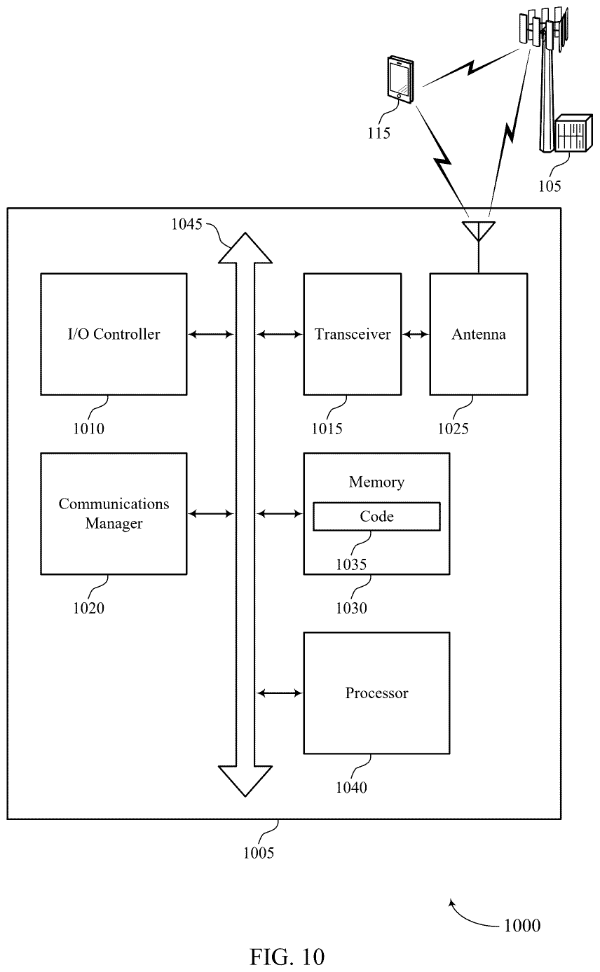

FIG. 10 shows a diagram of a system 1000 including a device 1005 that supports user equipment initiated uplink beam updates in wireless communications in accordance with one or more aspects of the present disclosure. The device 1005 may be an example of or include components of a device 705, a device 805, or a UE 115 as described herein. The device 1005 may communicate (e.g., wirelessly) with one or more other devices (e.g., network entities 105, UEs 115, or a combination thereof). The device 1005 may include components for bi-directional voice and data communications including components for transmitting and receiving communications, such as a communications manager 1020, an input/output (I/O) controller, such as an I/O controller 1010, a transceiver 1015, one or more antennas 1025, at least one memory 1030, code 1035, and at least one processor 1040. These components may be in electronic communication or otherwise coupled (e.g., operatively, communicatively, functionally, electronically, electrically) via one or more buses (e.g., a bus 1045).

The I/O controller 1010 may manage input and output signals for the device 1005. The I/O controller 1010 may also manage peripherals not integrated into the device 1005. In some cases, the I/O controller 1010 may represent a physical connection or port to an external peripheral. In some cases, the I/O controller 1010 may utilize an operating system such as iOS®, ANDROID®, MS-DOS®, MS-WINDOWS®, OS/2®, UNIX®, LINUX®, or another known operating system. Additionally, or alternatively, the I/O controller 1010 may represent or interact with a modem, a keyboard, a mouse, a touchscreen, or a similar device. In some cases, the I/O controller 1010 may be implemented as part of one or more processors, such as the at least one processor 1040. In some cases, a user may interact with the device 1005 via the I/O controller 1010 or via hardware components controlled by the I/O controller 1010.

In some cases, the device 1005 may include a single antenna. However, in some other cases, the device 1005 may have more than one antenna, which may be capable of concurrently transmitting or receiving multiple wireless transmissions. The transceiver 1015 may communicate bi-directionally via the one or more antennas 1025 using wired or wireless links as described herein. For example, the transceiver 1015 may represent a wireless transceiver and may communicate bi-directionally with another wireless transceiver. The transceiver 1015 may also include a modem to modulate the packets, to provide the modulated packets to one or more antennas 1025 for transmission, and to demodulate packets received from the one or more antennas 1025. The transceiver 1015, or the transceiver 1015 and one or more antennas 1025, may be an example of a transmitter 715, a transmitter 815, a receiver 710, a receiver 810, or any combination thereof or component thereof, as described herein.

The at least one memory 1030 may include random access memory (RAM) and read-only memory (ROM). The at least one memory 1030 may store computer-readable, computer-executable, or processor-executable code, such as the code 1035. The code 1035 may include instructions that, when executed by the at least one processor 1040, cause the device 1005 to perform various functions described herein. The code 1035 may be stored in a non-transitory computer-readable medium such as system memory or another type of memory. In some cases, the code 1035 may not be directly executable by the at least one processor 1040 but may cause a computer (e.g., when compiled and executed) to perform functions described herein. In some cases, the at least one memory 1030 may include, among other things, a basic I/O system (BIOS) which may control basic hardware or software operation such as the interaction with peripheral components or devices.

The at least one processor 1040 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1040 may be configured to operate a memory array using a memory controller. In some other cases, a memory controller may be integrated into the at least one processor 1040. The at least one processor 1040 may be configured to execute computer-readable instructions stored in a memory (e.g., the at least one memory 1030) to cause the device 1005 to perform various functions (e.g., functions or tasks supporting user equipment initiated uplink beam updates in wireless communications). For example, the device 1005 or a component of the device 1005 may include at least one processor 1040 and at least one memory 1030 coupled with or to the at least one processor 1040, the at least one processor 1040 and the at least one memory 1030 configured to perform various functions described herein.

In some examples, the at least one processor 1040 may include multiple processors and the at least one memory 1030 may include multiple memories. One or more of the multiple processors may be coupled with one or more of the multiple memories, which may, individually or collectively, be configured to perform various functions described herein. In some examples, the at least one processor 1040 may be a component of a processing system, which may refer to a system (such as a series) of machines, circuitry (including, for example, one or both of processor circuitry (which may include the at least one processor 1040) and memory circuitry (which may include the at least one memory 1030)), or components, that receives or obtains inputs and processes the inputs to produce, generate, or obtain a set of outputs. The processing system may be configured to perform one or more of the functions described herein. For example, the at least one processor 1040 or a processing system including the at least one processor 1040 may be configured to, configurable to, or operable to cause the device 1005 to perform one or more of the functions described herein. Further, as described herein, being “configured to,” being “configurable to,” and being “operable to” may be used interchangeably and may be associated with a capability, when executing code 1035 (e.g., processor-executable code) stored in the at least one memory 1030 or otherwise, to perform one or more of the functions described herein.

The communications manager 1020 may support wireless communications in accordance with examples as disclosed herein. For example, the communications manager 1020 is capable of, configured to, or operable to support a means for receiving configuration information that indicates a first set of beam update events that include one or more beam update events associated with one or more uplink conditions to trigger a transmission of a request to update a measurement report associated with a channel between the UE and a network entity, where the configuration information further indicates a second set of beam update events that include one or more beam update events associated with one or more downlink conditions to trigger the transmission of the request to update the measurement report. The communications manager 1020 is capable of, configured to, or operable to support a means for transmitting the request to update the measurement report in accordance with a detected uplink condition that meets the one or more uplink conditions of the first set of beam update events or a detected downlink condition that meets the one or more downlink conditions of the second set of beam update events.

Additionally, or alternatively, the communications manager 1020 may support wireless communications in accordance with examples as disclosed herein. For example, the communications manager 1020 is capable of, configured to, or operable to support a means for receiving configuration information that indicates a first set of beam update events that include one or more beam update events associated with one or more uplink conditions to trigger a transmission of a request to update a measurement report that includes one or more uplink channel metrics associated with a channel between the UE and a network entity. The communications manager 1020 is capable of, configured to, or operable to support a means for transmitting the request to update the measurement report in accordance with a detected uplink condition that meets the one or more uplink conditions of the first set of beam update events.

By including or configuring the communications manager 1020 in accordance with examples as described herein, the device 1005 may support techniques for UE uplink beam reporting as discussed herein, which may enhance communications reliability and provide for reduced latency.

In some examples, the communications manager 1020 may be configured to perform various operations (e.g., receiving, monitoring, transmitting) using or otherwise in cooperation with the transceiver 1015, the one or more antennas 1025, or any combination thereof. Although the communications manager 1020 is illustrated as a separate component, in some examples, one or more functions described with reference to the communications manager 1020 may be supported by or performed by the at least one processor 1040, the at least one memory 1030, the code 1035, or any combination thereof. For example, the code 1035 may include instructions executable by the at least one processor 1040 to cause the device 1005 to perform various aspects of user equipment initiated uplink beam updates in wireless communications as described herein, or the at least one processor 1040 and the at least one memory 1030 may be otherwise configured to, individually or collectively, perform or support such operations.

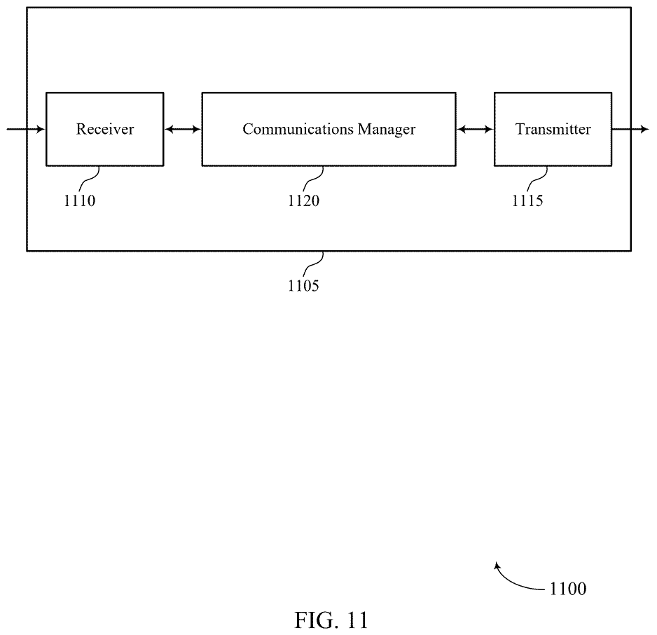

FIG. 11 shows a block diagram 1100 of a device 1105 that supports user equipment initiated uplink beam updates in wireless communications in accordance with one or more aspects of the present disclosure. The device 1105 may be an example of aspects of a network entity 105 as described herein. The device 1105 may include a receiver 1110, a transmitter 1115, and a communications manager 1120. The device 1105, or one or more components of the device 1105 (e.g., the receiver 1110, the transmitter 1115, the communications manager 1120), may include at least one processor, which may be coupled with at least one memory, to, individually or collectively, support or enable the described techniques. Each of these components may be in communication with one another (e.g., via one or more buses).

The receiver 1110 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1105. In some examples, the receiver 1110 may support obtaining information by receiving signals via one or more antennas. Additionally, or alternatively, the receiver 1110 may support obtaining information by receiving signals via one or more wired (e.g., electrical, fiber optic) interfaces, wireless interfaces, or any combination thereof.

The transmitter 1115 may provide a means for outputting (e.g., transmitting, providing, conveying, sending) information generated by other components of the device 1105. For example, the transmitter 1115 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1115 may support outputting information by transmitting signals via one or more antennas. Additionally, or alternatively, the transmitter 1115 may support outputting information by transmitting signals via one or more wired (e.g., electrical, fiber optic) interfaces, wireless interfaces, or any combination thereof. In some examples, the transmitter 1115 and the receiver 1110 may be co-located in a transceiver, which may include or be coupled with a modem.

The communications manager 1120, the receiver 1110, the transmitter 1115, or various combinations or components thereof may be examples of means for performing various aspects of user equipment initiated uplink beam updates in wireless communications as described herein. For example, the communications manager 1120, the receiver 1110, the transmitter 1115, or various combinations or components thereof may be capable of performing one or more of the functions described herein.

In some examples, the communications manager 1120, the receiver 1110, the transmitter 1115, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 1120, the receiver 1110, the transmitter 1115, or various combinations or components thereof may be implemented in code (e.g., as communications management software or firmware) executed by at least one processor (e.g., referred to as a processor-executable code). If implemented in code executed by at least one processor, the functions of the communications manager 1120, the receiver 1110, the transmitter 1115, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 1120 may be configured to perform various operations (e.g., receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations as described herein.

The communications manager 1120 may support wireless communications in accordance with examples as disclosed herein. For example, the communications manager 1120 is capable of, configured to, or operable to support a means for outputting configuration information that indicates a first set of beam update events that include one or more beam update events associated with one or more uplink conditions to trigger a request from a UE to update a measurement report associated with a communications channel of the UE, and a second set of beam update events that include one or more beam update events associated with one or more downlink conditions to trigger the request to update the measurement report. The communications manager 1120 is capable of, configured to, or operable to support a means for obtaining the request to update the measurement report that indicates a detected uplink condition at the UE meets the one or more uplink conditions of the first set of beam update events or a detected downlink condition at the UE meets the one or more downlink conditions of the second set of beam update events.

Additionally, or alternatively, the communications manager 1120 may support wireless communications in accordance with examples as disclosed herein. For example, the communications manager 1120 is capable of, configured to, or operable to support a means for outputting configuration information that indicates a first set of beam update events that include one or more beam update events associated with one or more uplink conditions at a UE to trigger a transmission by the UE of a request to update a measurement report that includes one or more uplink channel metrics associated with a communications channel of the UE. The communications manager 1120 is capable of, configured to, or operable to support a means for obtaining the request to update the measurement report that indicates a detected uplink condition at the UE meets the one or more uplink conditions of the first set of beam update events.

By including or configuring the communications manager 1120 in accordance with examples as described herein, the device 1105 (e.g., at least one processor controlling or otherwise coupled with the receiver 1110, the transmitter 1115, the communications manager 1120, or a combination thereof) may support techniques for UE uplink beam reporting as discussed herein, which may enhance communications reliability and provide for reduced latency.

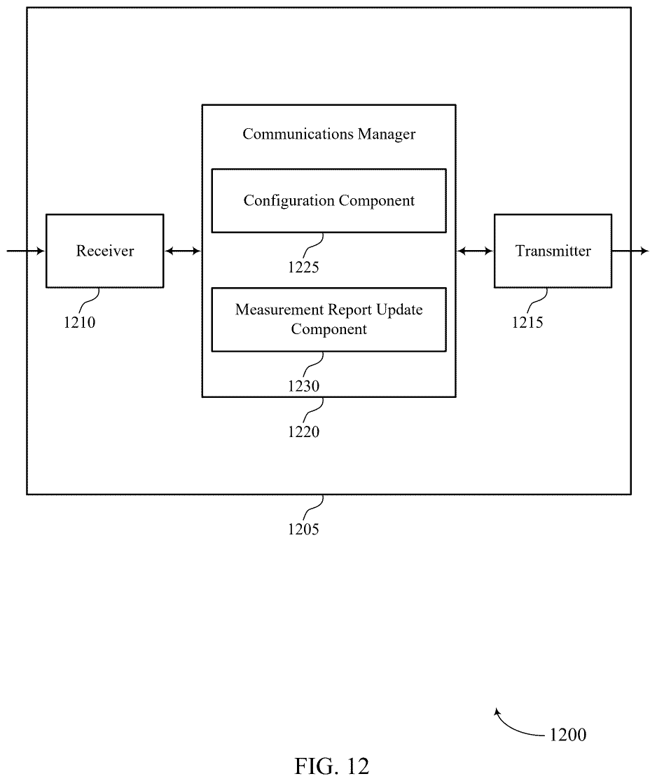

FIG. 12 shows a block diagram 1200 of a device 1205 that supports user equipment initiated uplink beam updates in wireless communications in accordance with one or more aspects of the present disclosure. The device 1205 may be an example of aspects of a device 1105 or a network entity 105 as described herein. The device 1205 may include a receiver 1210, a transmitter 1215, and a communications manager 1220. The device 1205, or one of more components of the device 1205 (e.g., the receiver 1210, the transmitter 1215, the communications manager 1220), may include at least one processor, which may be coupled with at least one memory, to support the described techniques. Each of these components may be in communication with one another (e.g., via one or more buses).

The receiver 1210 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1205. In some examples, the receiver 1210 may support obtaining information by receiving signals via one or more antennas. Additionally, or alternatively, the receiver 1210 may support obtaining information by receiving signals via one or more wired (e.g., electrical, fiber optic) interfaces, wireless interfaces, or any combination thereof.

The transmitter 1215 may provide a means for outputting (e.g., transmitting, providing, conveying, sending) information generated by other components of the device 1205. For example, the transmitter 1215 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1215 may support outputting information by transmitting signals via one or more antennas. Additionally, or alternatively, the transmitter 1215 may support outputting information by transmitting signals via one or more wired (e.g., electrical, fiber optic) interfaces, wireless interfaces, or any combination thereof. In some examples, the transmitter 1215 and the receiver 1210 may be co-located in a transceiver, which may include or be coupled with a modem.

The device 1205, or various components thereof, may be an example of means for performing various aspects of user equipment initiated uplink beam updates in wireless communications as described herein. For example, the communications manager 1220 may include a configuration component 1225 a measurement report update component 1230, or any combination thereof. The communications manager 1220 may be an example of aspects of a communications manager 1120 as described herein. In some examples, the communications manager 1220, or various components thereof, may be configured to perform various operations (e.g., receiving, obtaining, monitoring, outputting, transmitting) using or otherwise in cooperation with the receiver 1210, the transmitter 1215, or both. For example, the communications manager 1220 may receive information from the receiver 1210, send information to the transmitter 1215, or be integrated in combination with the receiver 1210, the transmitter 1215, or both to obtain information, output information, or perform various other operations as described herein.

The communications manager 1220 may support wireless communications in accordance with examples as disclosed herein. The configuration component 1225 is capable of, configured to, or operable to support a means for outputting configuration information that indicates a first set of beam update events that include one or more beam update events associated with one or more uplink conditions to trigger a request from a UE to update a measurement report associated with a communications channel of the UE, and a second set of beam update events that include one or more beam update events associated with one or more downlink conditions to trigger the request to update the measurement report. The measurement report update component 1230 is capable of, configured to, or operable to support a means for obtaining the request to update the measurement report that indicates a detected uplink condition at the UE meets the one or more uplink conditions of the first set of beam update events or a detected downlink condition at the UE meets the one or more downlink conditions of the second set of beam update events.

Additionally, or alternatively, the communications manager 1220 may support wireless communications in accordance with examples as disclosed herein. The configuration component 1225 is capable of, configured to, or operable to support a means for outputting configuration information that indicates a first set of beam update events that include one or more beam update events associated with one or more uplink conditions at a UE to trigger a transmission by the UE of a request to update a measurement report that includes one or more uplink channel metrics associated with a communications channel of the UE. The measurement report update component 1230 is capable of, configured to, or operable to support a means for obtaining the request to update the measurement report that indicates a detected uplink condition at the UE meets the one or more uplink conditions of the first set of beam update events.

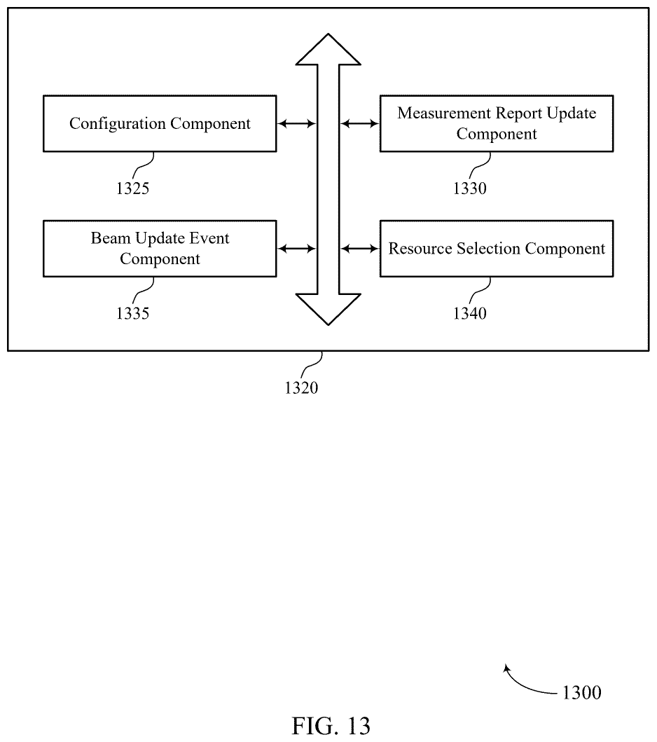

FIG. 13 shows a block diagram 1300 of a communications manager 1320 that supports user equipment initiated uplink beam updates in wireless communications in accordance with one or more aspects of the present disclosure. The communications manager 1320 may be an example of aspects of a communications manager 1120, a communications manager 1220, or both, as described herein. The communications manager 1320, or various components thereof, may be an example of means for performing various aspects of user equipment initiated uplink beam updates in wireless communications as described herein. For example, the communications manager 1320 may include a configuration component 1325, a measurement report update component 1330, a beam update event component 1335, a resource selection component 1340, or any combination thereof. Each of these components, or components or subcomponents thereof (e.g., one or more processors, one or more memories), may communicate, directly or indirectly, with one another (e.g., via one or more buses). The communications may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1320 may support wireless communications in accordance with examples as disclosed herein. The configuration component 1325 is capable of, configured to, or operable to support a means for outputting configuration information that indicates a first set of beam update events that include one or more beam update events associated with one or more uplink conditions to trigger a request from a UE to update a measurement report associated with a communications channel of the UE, and a second set of beam update events that include one or more beam update events associated with one or more downlink conditions to trigger the request to update the measurement report. The measurement report update component 1330 is capable of, configured to, or operable to support a means for obtaining the request to update the measurement report that indicates a detected uplink condition at the UE meets the one or more uplink conditions of the first set of beam update events or a detected downlink condition at the UE meets the one or more downlink conditions of the second set of beam update events.

In some examples, the one or more uplink conditions include one or more of a first uplink metric that is below a threshold value for a first beam used for communication between the UE and the network entity, a second uplink metric of a second beam that exceeds a corresponding uplink metric for the first beam, a third uplink metric of the second beam that exceeds an absolute threshold value associated with the third uplink metric, a predicted metric value of the first beam or the second beam that exceeds one or more threshold values, or a change in an uplink beam pattern.

In some examples, the request to update the measurement report indicates that the detected uplink condition meets the one or more uplink conditions and at least a first downlink condition associated with the first beam meets the one or more downlink conditions.

In some examples, one or more of the first uplink metric, second uplink metric, or third uplink metric include an uplink reference signal received power (RSRP), an uplink signal to interference and noise ratio (SINR), or an uplink throughput value, an uplink transmit power, or a maximum permissible exposure (MPE) value.

In some examples, the first set of beam update events include a first subset of beam update events associated with a first transmission-reception point (TRP) or a first component carrier, and a second subset of beam update events associated with a second TRP or a second component carrier.

In some examples, the one or more uplink conditions include a first uplink metric that has a value above or below a first threshold value, and where the first threshold value is associated with the first uplink metric and a first event of the first set of beam update events, and the first threshold value is based on one or more of an indication provided with the configuration information, a defined threshold value, or a capability of the UE.

In some examples, the configuration information indicates that one or more instances of a scheduling request that includes the request to update the measurement report are to be transmitted, followed by transmission of one or more instances of a random access channel request that indicates the request to update the measurement report in an absence of a response to the one or more instances of the scheduling request, where the scheduling request and the random access channel request use different uplink beams. In some examples, the request to update the measurement report includes an event indication that indicates a first beam update event of the first set of beam update events associated with the detected uplink condition, or a second beam update event of the second set of beam update events associated with the detected downlink condition. In some examples, the event indication includes a set of bits, and different bit values of the set of bits indicate different events or combinations of events of the first set of beam update events and the second set of beam update events.

In some examples, an uplink resource used for transmission of the request to update the measurement report indicates which of the first set of beam update events or the second set of beam update events is detected at the UE. In some examples, the configuration information further indicates a priority associated with each beam update event of the first set of beam update events and the second set of beam update events. In some examples, the configuration information indicates separate priority lists for the first set of beam update events and the second set of beam update events. In some examples, the configuration information indicates a common priority list for beam update events of the first set of beam update events and the second set of beam update events.

In some examples, the configuration information indicates a quantity of instances of the request to update the measurement report that are to be transmitted, or a prohibit timer value for a prohibit timer that is initiated upon transmission of an instance of the request to update the measurement report, and where the quantity of the instances of the request to update the measurement report, or the prohibit timer value, is based on a priority associated with each beam update event of the first set of beam update events and the second set of beam update events.

In some examples, the resource selection component 1340 is capable of, configured to, or operable to support a means for outputting a resource allocation for uplink transmission of an updated measurement report, the resource allocation indicating first resources for an updated uplink measurement report, second resources for an updated downlink measurement report, or joint resources for an updated joint uplink and downlink measurement report.

In some examples, the measurement report update component 1330 is capable of, configured to, or operable to support a means for obtaining an updated measurement report in accordance with the request to update the measurement report, where an uplink resource and format for the updated measurement report is indicated in the configuration information or is based on a beam update event of the first set of beam update events or the second set of beam update events that triggered the request to update the measurement report. In some examples, the updated measurement report has a format that includes a first field that indicates a metric associated with a measured reference signal, and a second field that indicates whether the metric is an uplink metric or a downlink metric.

Additionally, or alternatively, the communications manager 1320 may support wireless communications in accordance with examples as disclosed herein. In some examples, the configuration component 1325 is capable of, configured to, or operable to support a means for outputting configuration information that indicates a first set of beam update events that include one or more beam update events associated with one or more uplink conditions at a UE to trigger a transmission by the UE of a request to update a measurement report that includes one or more uplink channel metrics associated with a communications channel of the UE. In some examples, the measurement report update component 1330 is capable of, configured to, or operable to support a means for obtaining the request to update the measurement report that indicates a detected uplink condition at the UE meets the one or more uplink conditions of the first set of beam update events. In some examples, the one or more uplink conditions are configured separately from one or more downlink conditions associated with one or more downlink channel metrics.

In some examples, the one or more uplink conditions include one or more of a first uplink metric that is below a threshold value for a first beam used for communication between the UE and the network entity, a second uplink metric of a second beam that exceeds a corresponding uplink metric for the first beam, a third uplink metric of the second beam that exceeds an absolute threshold value associated with the third uplink metric, a predicted metric value of the first beam or the second beam that meets one or more prediction criteria, or a change in an uplink beam pattern. In some examples, the configuration information indicates that one or more instances of a scheduling request that includes the request to update the measurement report are to be transmitted, followed by transmission of one or more instances of a random access channel request that indicates the request to update the measurement report in an absence of a response to the one or more instances of the scheduling request, where the scheduling request and the random access channel request use different uplink beams.

In some examples, the measurement report update component 1330 is capable of, configured to, or operable to support a means for obtaining an updated measurement report from the UE in accordance with the request to update the measurement report, where an uplink resource and format for the updated measurement report is indicated in the configuration information or is based on a beam update event of the first set of beam update events that triggered the request to update the measurement report.

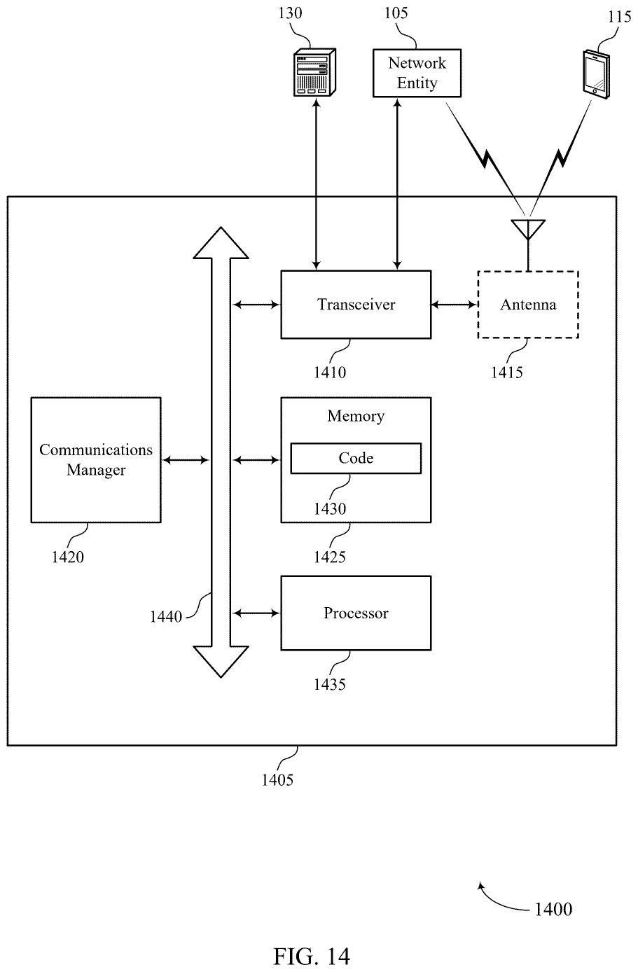

FIG. 14 shows a diagram of a system 1400 including a device 1405 that supports user equipment initiated uplink beam updates in wireless communications in accordance with one or more aspects of the present disclosure. The device 1405 may be an example of or include components of a device 1105, a device 1205, or a network entity 105 as described herein. The device 1405 may communicate with other network devices or network equipment such as one or more of the network entities 105, UEs 115, or any combination thereof. The communications may include communications over one or more wired interfaces, over one or more wireless interfaces, or any combination thereof. The device 1405 may include components that support outputting and obtaining communications, such as a communications manager 1420, a transceiver 1410, one or more antennas 1415, at least one memory 1425, code 1430, and at least one processor 1435. These components may be in electronic communication or otherwise coupled (e.g., operatively, communicatively, functionally, electronically, electrically) via one or more buses (e.g., a bus 1440).

The transceiver 1410 may support bi-directional communications via wired links, wireless links, or both as described herein. In some examples, the transceiver 1410 may include a wired transceiver and may communicate bi-directionally with another wired transceiver. Additionally, or alternatively, in some examples, the transceiver 1410 may include a wireless transceiver and may communicate bi-directionally with another wireless transceiver. In some examples, the device 1405 may include one or more antennas 1415, which may be capable of transmitting or receiving wireless transmissions (e.g., concurrently). The transceiver 1410 may also include a modem to modulate signals, to provide the modulated signals for transmission (e.g., by one or more antennas 1415, by a wired transmitter), to receive modulated signals (e.g., from one or more antennas 1415, from a wired receiver), and to demodulate signals. In some implementations, the transceiver 1410 may include one or more interfaces, such as one or more interfaces coupled with the one or more antennas 1415 that are configured to support various receiving or obtaining operations, or one or more interfaces coupled with the one or more antennas 1415 that are configured to support various transmitting or outputting operations, or a combination thereof. In some implementations, the transceiver 1410 may include or be configured for coupling with one or more processors or one or more memory components that are operable to perform or support operations based on received or obtained information or signals, or to generate information or other signals for transmission or other outputting, or any combination thereof. In some implementations, the transceiver 1410, or the transceiver 1410 and the one or more antennas 1415, or the transceiver 1410 and the one or more antennas 1415 and one or more processors or one or more memory components (e.g., the at least one processor 1435, the at least one memory 1425, or both), may be included in a chip or chip assembly that is installed in the device 1405. In some examples, the transceiver 1410 may be operable to support communications via one or more communications links (e.g., communication link(s) 125, backhaul communication link(s) 120, a midhaul communication link 162, a fronthaul communication link 168).

The at least one memory 1425 may include RAM, ROM, or any combination thereof. The at least one memory 1425 may store computer-readable, computer-executable, or processor-executable code, such as the code 1430. The code 1430 may include instructions that, when executed by one or more of the at least one processor 1435, cause the device 1405 to perform various functions described herein. The code 1430 may be stored in a non-transitory computer-readable medium such as system memory or another type of memory. In some cases, the code 1430 may not be directly executable by a processor of the at least one processor 1435 but may cause a computer (e.g., when compiled and executed) to perform functions described herein. In some cases, the at least one memory 1425 may include, among other things, a BIOS which may control basic hardware or software operation such as the interaction with peripheral components or devices. In some examples, the at least one processor 1435 may include multiple processors and the at least one memory 1425 may include multiple memories. One or more of the multiple processors may be coupled with one or more of the multiple memories which may, individually or collectively, be configured to perform various functions herein (for example, as part of a processing system).

The at least one processor 1435 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1435 may be configured to operate a memory array using a memory controller. In some other cases, a memory controller may be integrated into one or more of the at least one processor 1435. The at least one processor 1435 may be configured to execute computer-readable instructions stored in a memory (e.g., one or more of the at least one memory 1425) to cause the device 1405 to perform various functions (e.g., functions or tasks supporting user equipment initiated uplink beam updates in wireless communications). For example, the device 1405 or a component of the device 1405 may include at least one processor 1435 and at least one memory 1425 coupled with one or more of the at least one processor 1435, the at least one processor 1435 and the at least one memory 1425 configured to perform various functions described herein. The at least one processor 1435 may be an example of a cloud-computing platform (e.g., one or more physical nodes and supporting software such as operating systems, virtual machines, or container instances) that may host the functions (e.g., by executing code 1430) to perform the functions of the device 1405. The at least one processor 1435 may be any one or more suitable processors capable of executing scripts or instructions of one or more software programs stored in the device 1405 (such as within one or more of the at least one memory 1425).

In some examples, the at least one processor 1435 may include multiple processors and the at least one memory 1425 may include multiple memories. One or more of the multiple processors may be coupled with one or more of the multiple memories, which may, individually or collectively, be configured to perform various functions herein. In some examples, the at least one processor 1435 may be a component of a processing system, which may refer to a system (such as a series) of machines, circuitry (including, for example, one or both of processor circuitry (which may include the at least one processor 1435) and memory circuitry (which may include the at least one memory 1425)), or components, that receives or obtains inputs and processes the inputs to produce, generate, or obtain a set of outputs. The processing system may be configured to perform one or more of the functions described herein. For example, the at least one processor 1435 or a processing system including the at least one processor 1435 may be configured to, configurable to, or operable to cause the device 1405 to perform one or more of the functions described herein. Further, as described herein, being “configured to,” being “configurable to,” and being “operable to” may be used interchangeably and may be associated with a capability, when executing code stored in the at least one memory 1425 or otherwise, to perform one or more of the functions described herein.

In some examples, a bus 1440 may support communications of (e.g., within) a protocol layer of a protocol stack. In some examples, a bus 1440 may support communications associated with a logical channel of a protocol stack (e.g., between protocol layers of a protocol stack), which may include communications performed within a component of the device 1405, or between different components of the device 1405 that may be co-located or located in different locations (e.g., where the device 1405 may refer to a system in which one or more of the communications manager 1420, the transceiver 1410, the at least one memory 1425, the code 1430, and the at least one processor 1435 may be located in one of the different components or divided between different components).

In some examples, the communications manager 1420 may manage aspects of communications with a core network 130 (e.g., via one or more wired or wireless backhaul links). For example, the communications manager 1420 may manage the transfer of data communications for client devices, such as one or more UEs 115. In some examples, the communications manager 1420 may manage communications with one or more other network entities 105, and may include a controller or scheduler for controlling communications with UEs 115 (e.g., in cooperation with the one or more other network devices). In some examples, the communications manager 1420 may support an X2 interface within an LTE/LTE-A wireless communications network technology to provide communication between network entities 105.

The communications manager 1420 may support wireless communications in accordance with examples as disclosed herein. For example, the communications manager 1420 is capable of, configured to, or operable to support a means for outputting configuration information that indicates a first set of beam update events that include one or more beam update events associated with one or more uplink conditions to trigger a request from a UE to update a measurement report associated with a communications channel of the UE, and a second set of beam update events that include one or more beam update events associated with one or more downlink conditions to trigger the request to update the measurement report. The communications manager 1420 is capable of, configured to, or operable to support a means for obtaining the request to update the measurement report that indicates a detected uplink condition at the UE meets the one or more uplink conditions of the first set of beam update events or a detected downlink condition at the UE meets the one or more downlink conditions of the second set of beam update events.

Additionally, or alternatively, the communications manager 1420 may support wireless communications in accordance with examples as disclosed herein. For example, the communications manager 1420 is capable of, configured to, or operable to support a means for outputting configuration information that indicates a first set of beam update events that include one or more beam update events associated with one or more uplink conditions at a UE to trigger a transmission by the UE of a request to update a measurement report that includes one or more uplink channel metrics associated with a communications channel of the UE. The communications manager 1420 is capable of, configured to, or operable to support a means for obtaining the request to update the measurement report that indicates a detected uplink condition at the UE meets the one or more uplink conditions of the first set of beam update events.

By including or configuring the communications manager 1420 in accordance with examples as described herein, the device 1405 may support techniques for UE uplink beam reporting as discussed herein, which may enhance communications reliability and provide for reduced latency.

In some examples, the communications manager 1420 may be configured to perform various operations (e.g., receiving, obtaining, monitoring, outputting, transmitting) using or otherwise in cooperation with the transceiver 1410, the one or more antennas 1415 (e.g., where applicable), or any combination thereof. Although the communications manager 1420 is illustrated as a separate component, in some examples, one or more functions described with reference to the communications manager 1420 may be supported by or performed by the transceiver 1410, one or more of the at least one processor 1435, one or more of the at least one memory 1425, the code 1430, or any combination thereof (for example, by a processing system including at least a portion of the at least one processor 1435, the at least one memory 1425, the code 1430, or any combination thereof). For example, the code 1430 may include instructions executable by one or more of the at least one processor 1435 to cause the device 1405 to perform various aspects of user equipment initiated uplink beam updates in wireless communications as described herein, or the at least one processor 1435 and the at least one memory 1425 may be otherwise configured to, individually or collectively, perform or support such operations.

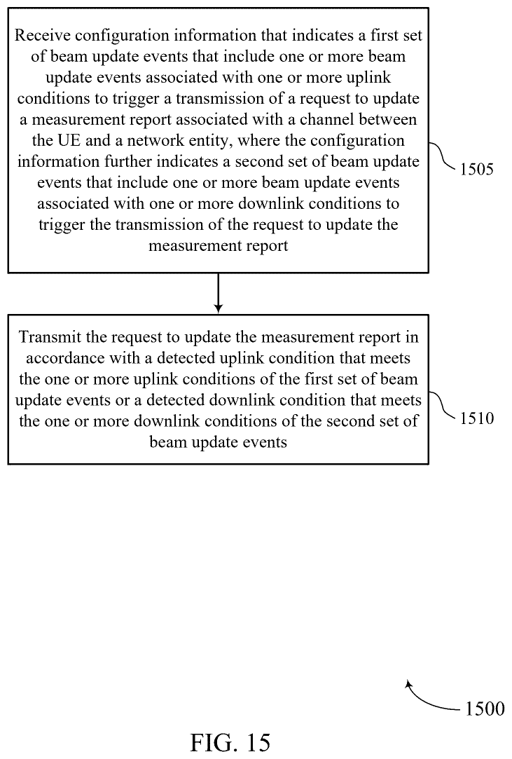

FIG. 15 shows a flowchart illustrating a method 1500 that supports user equipment initiated uplink beam updates in wireless communications in accordance with one or more aspects of the present disclosure. The operations of the method 1500 may be implemented by a UE or its components as described herein. For example, the operations of the method 1500 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1505, the method may include receiving configuration information that indicates a first set of beam update events that include one or more beam update events associated with one or more uplink conditions to trigger a transmission of a request to update a measurement report associated with a channel between the UE and a network entity, where the configuration information further indicates a second set of beam update events that include one or more beam update events associated with one or more downlink conditions to trigger the transmission of the request to update the measurement report. The operations of 1505 may be performed in accordance with examples as disclosed herein. In some examples, aspects of the operations of 1505 may be performed by a configuration component 925 as described with reference to FIG. 9.

At 1510, the method may include transmitting the request to update the measurement report in accordance with a detected uplink condition that meets the one or more uplink conditions of the first set of beam update events or a detected downlink condition that meets the one or more downlink conditions of the second set of beam update events. The operations of 1510 may be performed in accordance with examples as disclosed herein. In some examples, aspects of the operations of 1510 may be performed by a measurement report update component 930 as described with reference to FIG. 9.

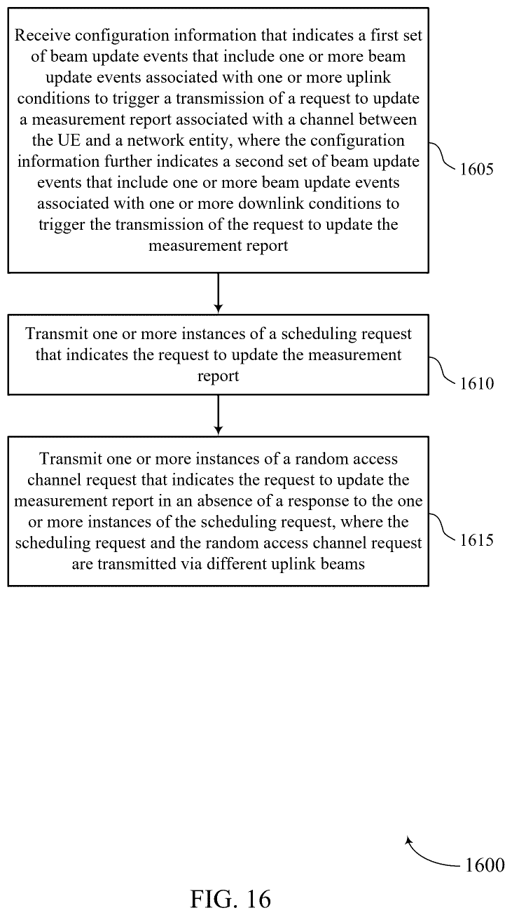

FIG. 16 shows a flowchart illustrating a method 1600 that supports user equipment initiated uplink beam updates in wireless communications in accordance with one or more aspects of the present disclosure. The operations of the method 1600 may be implemented by a UE or its components as described herein. For example, the operations of the method 1600 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1605, the method may include receiving configuration information that indicates a first set of beam update events that include one or more beam update events associated with one or more uplink conditions to trigger a transmission of a request to update a measurement report associated with a channel between the UE and a network entity, where the configuration information further indicates a second set of beam update events that include one or more beam update events associated with one or more downlink conditions to trigger the transmission of the request to update the measurement report. The operations of 1605 may be performed in accordance with examples as disclosed herein. In some examples, aspects of the operations of 1605 may be performed by a configuration component 925 as described with reference to FIG. 9.

At 1610, the method may include transmitting one or more instances of a scheduling request that indicates the request to update the measurement report. The operations of 1610 may be performed in accordance with examples as disclosed herein. In some examples, aspects of the operations of 1610 may be performed by a measurement report update component 930 as described with reference to FIG. 9.

At 1615, the method may include transmitting one or more instances of a random access channel request that indicates the request to update the measurement report in an absence of a response to the one or more instances of the scheduling request, where the scheduling request and the random access channel request are transmitted via different uplink beams. The operations of 1615 may be performed in accordance with examples as disclosed herein. In some examples, aspects of the operations of 1615 may be performed by a measurement report update component 930 as described with reference to FIG. 9.

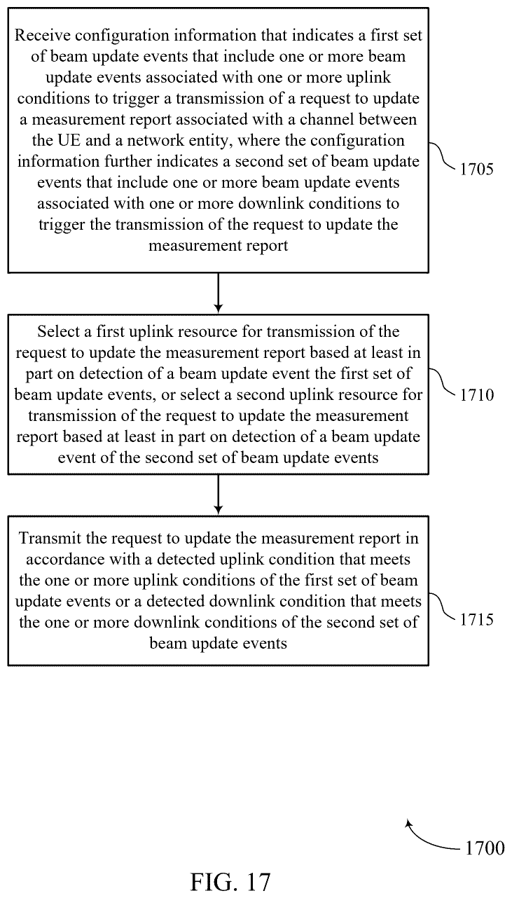

FIG. 17 shows a flowchart illustrating a method 1700 that supports user equipment initiated uplink beam updates in wireless communications in accordance with one or more aspects of the present disclosure. The operations of the method 1700 may be implemented by a UE or its components as described herein. For example, the operations of the method 1700 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1705, the method may include receiving configuration information that indicates a first set of beam update events that include one or more beam update events associated with one or more uplink conditions to trigger a transmission of a request to update a measurement report associated with a channel between the UE and a network entity, where the configuration information further indicates a second set of beam update events that include one or more beam update events associated with one or more downlink conditions to trigger the transmission of the request to update the measurement report. The operations of 1705 may be performed in accordance with examples as disclosed herein. In some examples, aspects of the operations of 1705 may be performed by a configuration component 925 as described with reference to FIG. 9.

At 1710, the method may include selecting a first uplink resource for transmission of the request to update the measurement report based at least in part on detection of a beam update event of the first set of beam update events, or selecting a second uplink resource for transmission of the request to update the measurement report based at least in part on detection of a beam update event of the second set of beam update events. The operations of 1710 may be performed in accordance with examples as disclosed herein. In some examples, aspects of the operations of 1710 may be performed by a resource selection component 940 as described with reference to FIG. 9.

At 1715, the method may include transmitting the request to update the measurement report in accordance with a detected uplink condition that meets the one or more uplink conditions of the first set of beam update events or a detected downlink condition that meets the one or more downlink conditions of the second set of beam update events. The operations of 1715 may be performed in accordance with examples as disclosed herein. In some examples, aspects of the operations of 1715 may be performed by a measurement report update component 930 as described with reference to FIG. 9.

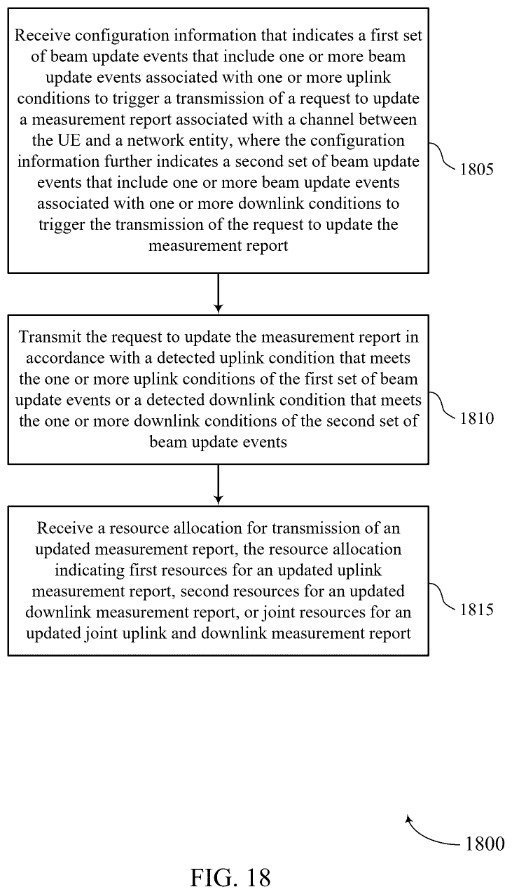

FIG. 18 shows a flowchart illustrating a method 1800 that supports user equipment initiated uplink beam updates in wireless communications in accordance with one or more aspects of the present disclosure. The operations of the method 1800 may be implemented by a UE or its components as described herein. For example, the operations of the method 1800 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1805, the method may include receiving configuration information that indicates a first set of beam update events that include one or more beam update events associated with one or more uplink conditions to trigger a transmission of a request to update a measurement report associated with a channel between the UE and a network entity, where the configuration information further indicates a second set of beam update events that include one or more beam update events associated with one or more downlink conditions to trigger the transmission of the request to update the measurement report. The operations of 1805 may be performed in accordance with examples as disclosed herein. In some examples, aspects of the operations of 1805 may be performed by a configuration component 925 as described with reference to FIG. 9.

At 1810, the method may include transmitting the request to update the measurement report in accordance with a detected uplink condition that meets the one or more uplink conditions of the first set of beam update events or a detected downlink condition that meets the one or more downlink conditions of the second set of beam update events. The operations of 1810 may be performed in accordance with examples as disclosed herein. In some examples, aspects of the operations of 1810 may be performed by a measurement report update component 930 as described with reference to FIG. 9.

At 1815, the method may include receiving a resource allocation for transmission of an updated measurement report, the resource allocation indicating first resources for an updated uplink measurement report, second resources for an updated downlink measurement report, or joint resources for an updated joint uplink and downlink measurement report. The operations of 1815 may be performed in accordance with examples as disclosed herein. In some examples, aspects of the operations of 1815 may be performed by a resource selection component 940 as described with reference to FIG. 9.

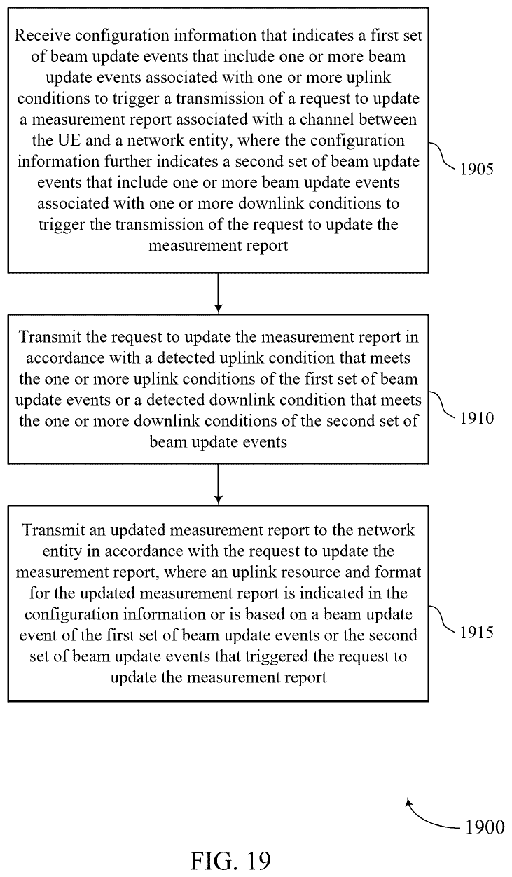

FIG. 19 shows a flowchart illustrating a method 1900 that supports user equipment initiated uplink beam updates in wireless communications in accordance with one or more aspects of the present disclosure. The operations of the method 1900 may be implemented by a UE or its components as described herein. For example, the operations of the method 1900 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1905, the method may include receiving configuration information that indicates a first set of beam update events that include one or more beam update events associated with one or more uplink conditions to trigger a transmission of a request to update a measurement report associated with a channel between the UE and a network entity, where the configuration information further indicates a second set of beam update events that include one or more beam update events associated with one or more downlink conditions to trigger the transmission of the request to update the measurement report. The operations of 1905 may be performed in accordance with examples as disclosed herein. In some examples, aspects of the operations of 1905 may be performed by a configuration component 925 as described with reference to FIG. 9.

At 1910, the method may include transmitting the request to update the measurement report in accordance with a detected uplink condition that meets the one or more uplink conditions of the first set of beam update events or a detected downlink condition that meets the one or more downlink conditions of the second set of beam update events. The operations of 1910 may be performed in accordance with examples as disclosed herein. In some examples, aspects of the operations of 1910 may be performed by a measurement report update component 930 as described with reference to FIG. 9.

At 1915, the method may include transmitting an updated measurement report to the network entity in accordance with the request to update the measurement report, where an uplink resource and format for the updated measurement report is indicated in the configuration information or is based on a beam update event of the first set of beam update events or the second set of beam update events that triggered the request to update the measurement report. The operations of 1915 may be performed in accordance with examples as disclosed herein. In some examples, aspects of the operations of 1915 may be performed by a measurement report update component 930 as described with reference to FIG. 9.

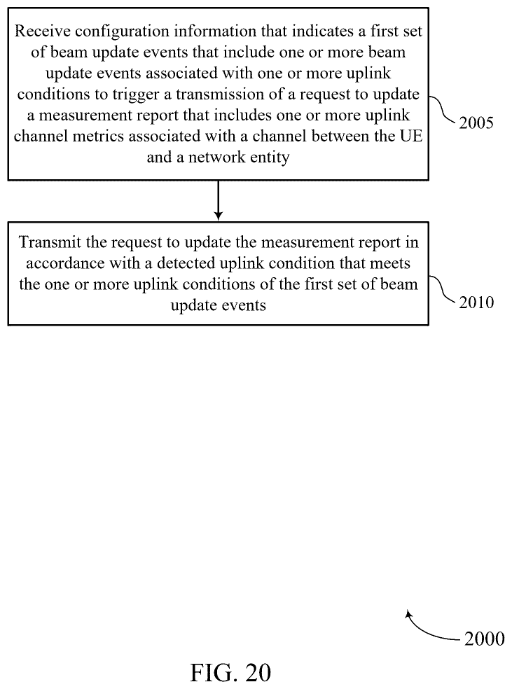

FIG. 20 shows a flowchart illustrating a method 2000 that supports user equipment initiated uplink beam updates in wireless communications in accordance with one or more aspects of the present disclosure. The operations of the method 2000 may be implemented by a UE or its components as described herein. For example, the operations of the method 2000 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 2005, the method may include receiving configuration information that indicates a first set of beam update events that include one or more beam update events associated with one or more uplink conditions to trigger a transmission of a request to update a measurement report that includes one or more uplink channel metrics associated with a channel between the UE and a network entity. The operations of 2005 may be performed in accordance with examples as disclosed herein. In some examples, aspects of the operations of 2005 may be performed by a configuration component 925 as described with reference to FIG. 9.

At 2010, the method may include transmitting the request to update the measurement report in accordance with a detected uplink condition that meets the one or more uplink conditions of the first set of beam update events. The operations of 2010 may be performed in accordance with examples as disclosed herein. In some examples, aspects of the operations of 2010 may be performed by a measurement report update component 930 as described with reference to FIG. 9.

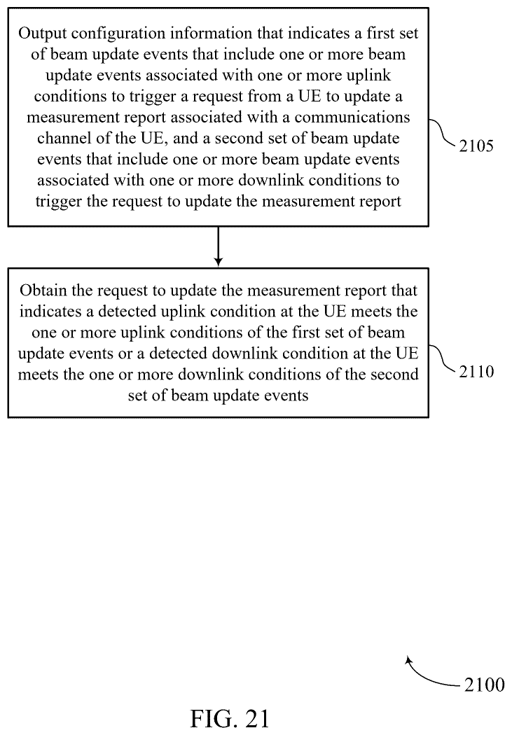

FIG. 21 shows a flowchart illustrating a method 2100 that supports user equipment initiated uplink beam updates in wireless communications in accordance with one or more aspects of the present disclosure. The operations of the method 2100 may be implemented by a network entity or its components as described herein. For example, the operations of the method 2100 may be performed by a network entity as described with reference to FIGS. 1 through 6 and 11 through 14. In some examples, a network entity may execute a set of instructions to control the functional elements of the network entity to perform the described functions. Additionally, or alternatively, the network entity may perform aspects of the described functions using special-purpose hardware.

At 2105, the method may include outputting configuration information that indicates a first set of beam update events that include one or more beam update events associated with one or more uplink conditions to trigger a request from a UE to update a measurement report associated with a communications channel of the UE, and a second set of beam update events that include one or more beam update events associated with one or more downlink conditions to trigger the request to update the measurement report. The operations of 2105 may be performed in accordance with examples as disclosed herein. In some examples, aspects of the operations of 2105 may be performed by a configuration component 1325 as described with reference to FIG. 13.

At 2110, the method may include obtaining the request to update the measurement report that indicates a detected uplink condition at the UE meets the one or more uplink conditions of the first set of beam update events or a detected downlink condition at the UE meets the one or more downlink conditions of the second set of beam update events. The operations of 2110 may be performed in accordance with examples as disclosed herein. In some examples, aspects of the operations of 2110 may be performed by a measurement report update component 1330 as described with reference to FIG. 13.

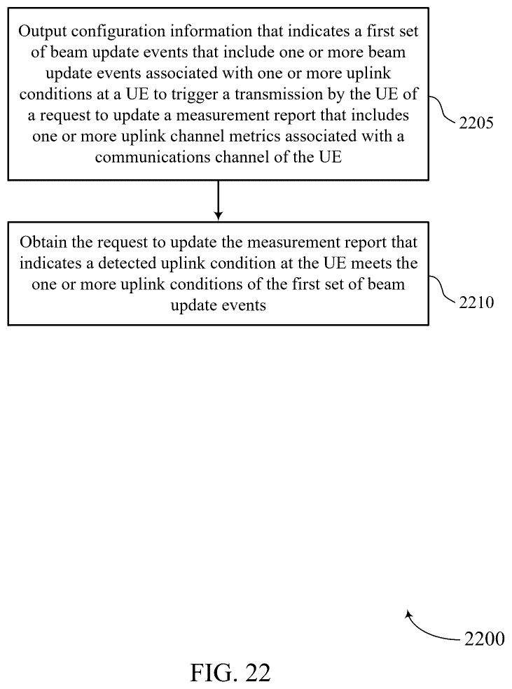

FIG. 22 shows a flowchart illustrating a method 2200 that supports user equipment initiated uplink beam updates in wireless communications in accordance with one or more aspects of the present disclosure. The operations of the method 2200 may be implemented by a network entity or its components as described herein. For example, the operations of the method 2200 may be performed by a network entity as described with reference to FIGS. 1 through 6 and 11 through 14. In some examples, a network entity may execute a set of instructions to control the functional elements of the network entity to perform the described functions. Additionally, or alternatively, the network entity may perform aspects of the described functions using special-purpose hardware.

At 2205, the method may include outputting configuration information that indicates a first set of beam update events that include one or more beam update events associated with one or more uplink conditions at a UE to trigger a transmission by the UE of a request to update a measurement report that includes one or more uplink channel metrics associated with a communications channel of the UE. The operations of 2205 may be performed in accordance with examples as disclosed herein. In some examples, aspects of the operations of 2205 may be performed by a configuration component 1325 as described with reference to FIG. 13.

At 2210, the method may include obtaining the request to update the measurement report that indicates a detected uplink condition at the UE meets the one or more uplink conditions of the first set of beam update events. The operations of 2210 may be performed in accordance with examples as disclosed herein. In some examples, aspects of the operations of 2210 may be performed by a measurement report update component 1330 as described with reference to FIG. 13.

The following provides an overview of aspects of the present disclosure:
Aspect 1: A method for wireless communications at a UE, comprising: receiving configuration information that indicates a first set of beam update events that include one or more beam update events associated with one or more uplink conditions to trigger a transmission of a request to update a measurement report associated with a channel between the UE and a network entity, wherein the configuration information further indicates a second set of beam update events that include one or more beam update events associated with one or more downlink conditions to trigger the transmission of the request to update the measurement report; and transmitting the request to update the measurement report in accordance with a detected uplink condition that meets the one or more uplink conditions of the first set of beam update events or a detected downlink condition that meets the one or more downlink conditions of the second set of beam update events.
Aspect 2: The method of aspect 1, wherein the one or more uplink conditions include one or more of a first uplink metric that is below a threshold value for a first beam used for communication between the UE and the network entity, a second uplink metric of a second beam that exceeds a corresponding uplink metric for the first beam, a third uplink metric of the second beam that exceeds an absolute threshold value associated with the third uplink metric, a predicted metric value of the first beam or the second beam that meets one or more prediction criteria, or a change in an uplink beam pattern.
Aspect 3: The method of aspect 1, wherein the one or more uplink conditions include one or more of a first uplink metric that is below a threshold value for a first beam used for communication between the UE and the network entity, a second uplink metric of a second beam that exceeds a corresponding uplink metric for the first beam, a third uplink metric of the second beam that exceeds an absolute threshold value associated with the third uplink metric, a predicted metric value of the first beam or the second beam that meets one or more prediction criteria, or a change in an uplink beam pattern.
Aspect 4: The method of aspect 3, the transmitting comprising: transmitting the request to update the measurement report in accordance with the detected uplink condition that meets the one or more uplink conditions and at least a first downlink condition associated with the first beam that meets the one or more downlink conditions.
Aspect 5: The method of any of aspects 3 through 4, wherein one or more of the first uplink metric, second uplink metric, or third uplink metric include an uplink reference signal received power (RSRP), an uplink signal to interference and noise ratio (SINR), an uplink throughput value, an uplink transmit power, or a maximum permissible exposure (MPE) value.
Aspect 6: The method of any of aspects 1 through 5, wherein the first set of beam update events include a first subset of beam update events associated with a first transmission-reception point (TRP) or a first component carrier, and a second subset of beam update events associated with a second TRP or a second component carrier.
Aspect 7: The method of any of aspects 1 through 6, wherein the one or more uplink conditions include a first uplink metric that has a value above or below a first threshold value, and the first threshold value is associated with the first uplink metric and a first event of the first set of beam update events, and the first threshold value is based at least in part on one or more of an indication provided with the configuration information, a defined threshold value, or a capability of the UE.
Aspect 8: The method of any of aspects 1 through 7, the transmitting comprising: transmitting one or more instances of a scheduling request that indicates the request to update the measurement report; and transmitting one or more instances of a random access channel request that indicates the request to update the measurement report in an absence of a response to the one or more instances of the scheduling request, wherein the scheduling request and the random access channel request are transmitted via different uplink beams.
Aspect 9: The method of any of aspects 1 through 8, the transmitting comprising: transmitting one or more instances of a random access channel request that indicates the request to update the measurement report based at least in part on the detected uplink condition being below a threshold value.
Aspect 10: The method of any of aspects 1 through 9, wherein the request to update the measurement report includes an event indication that indicates a first beam update event of the first set of beam update events associated with the detected uplink condition, or a second beam update event of the second set of beam update events associated with the detected downlink condition.
Aspect 11: The method of aspect 10, wherein the event indication comprises a set of bits, and different bit values of the set of bits indicate different events or combinations of events of the first set of beam update events and the second set of beam update events.
Aspect 12: The method of any of aspects 1 through 11, further comprising: selecting a first uplink resource for transmission of the request to update the measurement report based at least in part on detection of a beam update event of the first set of beam update events, or selecting a second uplink resource for transmission of the request to update the measurement report based at least in part on detection of a beam update event of the second set of beam update events.
Aspect 13: The method of any of aspects 1 through 12, wherein the configuration information further indicates a priority associated with each beam update event of the first set of beam update events and the second set of beam update events.
Aspect 14: The method of aspect 13, wherein the configuration information indicates separate priority lists for the first set of beam update events and the second set of beam update events.
Aspect 15: The method of any of aspects 13 through 14, wherein the configuration information indicates a common priority list for beam update events of the first set of beam update events and the second set of beam update events.
Aspect 16: The method of any of aspects 1 through 15, the transmitting comprising: transmitting a plurality of instances of the request to update the measurement report, a quantity of the plurality of instances of the request to update the measurement report based at least in part on a configured quantity or a prohibit timer that is initiated upon transmission of an instance of the request to update the measurement report.
Aspect 17: The method of any of aspects 1 through 16, wherein the quantity of the plurality of instances of the request to update the measurement report, or a value of the prohibit timer, is based at least in part on a priority associated with each beam update event of the first set of beam update events and the second set of beam update events.
Aspect 18: The method of any of aspects 1 through 17, further comprising: receiving a resource allocation for transmission of an updated measurement report, the resource allocation indicating first resources for an updated uplink measurement report, second resources for an updated downlink measurement report, or joint resources for an updated joint uplink and downlink measurement report.
Aspect 19: The method of any of aspects 1 through 18, further comprising: transmitting an updated measurement report to the network entity in accordance with the request to update the measurement report, wherein an uplink resource and format for the updated measurement report is indicated in the configuration information or is based at least in part on a beam update event of the first set of beam update events or the second set of beam update events that triggered the request to update the measurement report.
Aspect 20: The method of aspect 19, wherein the updated measurement report has a format that includes a first field that indicates a metric associated with a measured reference signal, and a second field that indicates whether the metric is an uplink metric or a downlink metric.
Aspect 21: A method for wireless communications at a UE, comprising: receiving configuration information that indicates a first set of beam update events that include one or more beam update events associated with one or more uplink conditions to trigger a transmission of a request to update a measurement report that includes one or more uplink channel metrics associated with a channel between the UE and a network entity; and transmitting the request to update the measurement report in accordance with a detected uplink condition that meets the one or more uplink conditions of the first set of beam update events.
Aspect 22: The method of aspect 21, wherein the one or more uplink conditions are configured separately from one or more downlink conditions associated with one or more downlink channel metrics.
Aspect 23: The method of any of aspects 21 through 22, wherein the one or more uplink conditions include one or more of a first uplink metric that is below a threshold value for a first beam used for communication between the UE and the network entity, a second uplink metric of a second beam that exceeds a corresponding uplink metric for the first beam, a third uplink metric of the second beam that exceeds an absolute threshold value associated with the third uplink metric, a predicted metric value of the first beam or the second beam that meets one or more prediction criteria, or a change in an uplink beam pattern.
Aspect 24: The method of any of aspects 21 through 23, the transmitting comprising: transmitting one or more instances of a scheduling request that indicates the request to update the measurement report; and transmitting one or more instances of a random access channel request that indicates the request to update the measurement report in an absence of a response to the one or more instances of the scheduling request, wherein the scheduling request and the random access channel request are transmitted via different uplink beams.
Aspect 25: The method of any of aspects 21 through 24, the transmitting comprising: transmitting one or more instances of a random access channel request that indicates the request to update the measurement report based at least in part on the detected uplink condition being below a threshold value.
Aspect 26: The method of any of aspects 21 through 25, further comprising: transmitting an updated measurement report to the network entity in accordance with the request to update the measurement report, wherein an uplink resource and format for the updated measurement report is indicated in the configuration information or is based at least in part on a beam update event of the first set of beam update events that triggered the request to update the measurement report.
Aspect 27: A method for wireless communications at a network entity, comprising: outputting configuration information that indicates a first set of beam update events that include one or more beam update events associated with one or more uplink conditions to trigger a request from a UE to update a measurement report associated with a communications channel of the UE, and a second set of beam update events that include one or more beam update events associated with one or more downlink conditions to trigger the request to update the measurement report; and obtaining the request to update the measurement report that indicates a detected uplink condition at the UE meets the one or more uplink conditions of the first set of beam update events or a detected downlink condition at the UE meets the one or more downlink conditions of the second set of beam update events.
Aspect 28: The method of aspect 27, wherein the one or more uplink conditions include one or more of a first uplink metric that is below a threshold value for a first beam used for communication between the UE and the network entity, a second uplink metric of a second beam that exceeds a corresponding uplink metric for the first beam, a third uplink metric of the second beam that exceeds an absolute threshold value associated with the third uplink metric, a predicted metric value of the first beam or the second beam that exceeds one or more threshold values, or a change in an uplink beam pattern.
Aspect 29: The method of aspect 28, wherein the request to update the measurement report indicates that the detected uplink condition meets the one or more uplink conditions and at least a first downlink condition associated with the first beam meets the one or more downlink conditions.
Aspect 30: The method of any of aspects 28 through 29, wherein one or more of the first uplink metric, second uplink metric, or third uplink metric include an uplink reference signal received power (RSRP), an uplink signal to interference and noise ratio (SINR), or an uplink throughput value, an uplink transmit power, or a maximum permissible exposure (MPE) value.
Aspect 31: The method of any of aspects 27 through 30, wherein the first set of beam update events include a first subset of beam update events associated with a first transmission-reception point (TRP) or a first component carrier, and a second subset of beam update events associated with a second TRP or a second component carrier.
Aspect 32: The method of any of aspects 27 through 31, wherein the one or more uplink conditions include a first uplink metric that has a value above or below a first threshold value, and the first threshold value is associated with the first uplink metric and a first event of the first set of beam update events, and the first threshold value is based at least in part on one or more of an indication provided with the configuration information, a defined threshold value, or a capability of the UE.
Aspect 33: The method of any of aspects 27 through 32, wherein the configuration information indicates that one or more instances of a scheduling request that includes the request to update the measurement report are to be transmitted, followed by transmission of one or more instances of a random access channel request that indicates the request to update the measurement report in an absence of a response to the one or more instances of the scheduling request, the scheduling request and the random access channel request use different uplink beams.
Aspect 34: The method of any of aspects 27 through 33, wherein the request to update the measurement report includes an event indication that indicates a first beam update event of the first set of beam update events associated with the detected uplink condition, or a second beam update event of the second set of beam update events associated with the detected downlink condition.
Aspect 35: The method of aspect 34, wherein the event indication comprises a set of bits, and different bit values of the set of bits indicate different events or combinations of events of the first set of beam update events and the second set of beam update events.
Aspect 36: The method of any of aspects 27 through 35, wherein an uplink resource used for transmission of the request to update the measurement report indicates which of the first set of beam update events or the second set of beam update events is detected at the UE.
Aspect 37: The method of any of aspects 27 through 36, wherein the configuration information further indicates a priority associated with each beam update event of the first set of beam update events and the second set of beam update events.
Aspect 38: The method of aspect 37, wherein the configuration information indicates separate priority lists for the first set of beam update events and the second set of beam update events.
Aspect 39: The method of any of aspects 37 through 38, wherein the configuration information indicates a common priority list for beam update events of the first set of beam update events and the second set of beam update events.
Aspect 40: The method of any of aspects 27 through 39, wherein the configuration information indicates a quantity of instances of the request to update the measurement report that are to be transmitted, or a prohibit timer value for a prohibit timer that is initiated upon transmission of an instance of the request to update the measurement report, and the quantity of the instances of the request to update the measurement report, or the prohibit timer value, is based at least in part on a priority associated with each beam update event of the first set of beam update events and the second set of beam update events.
Aspect 41: The method of any of aspects 27 through 40, further comprising: outputting a resource allocation for uplink transmission of an updated measurement report, the resource allocation indicating first resources for an updated uplink measurement report, second resources for an updated downlink measurement report, or joint resources for an updated joint uplink and downlink measurement report.
Aspect 42: The method of any of aspects 27 through 41, further comprising: obtaining an updated measurement report in accordance with the request to update the measurement report, wherein an uplink resource and format for the updated measurement report is indicated in the configuration information or is based at least in part on a beam update event of the first set of beam update events or the second set of beam update events that triggered the request to update the measurement report.
Aspect 43: The method of aspect 42, wherein the updated measurement report has a format that includes a first field that indicates a metric associated with a measured reference signal, and a second field that indicates whether the metric is an uplink metric or a downlink metric.
Aspect 44: A method for wireless communications at a network entity, comprising: outputting configuration information that indicates a first set of beam update events that include one or more beam update events associated with one or more uplink conditions at a UE to trigger a transmission by the UE of a request to update a measurement report that includes one or more uplink channel metrics associated with a communications channel of the UE; and obtaining the request to update the measurement report that indicates a detected uplink condition at the UE meets the one or more uplink conditions of the first set of beam update events.
Aspect 45: The method of aspect 44, wherein the one or more uplink conditions are configured separately from one or more downlink conditions associated with one or more downlink channel metrics.
Aspect 46: The method of any of aspects 44 through 45, wherein the one or more uplink conditions include one or more of a first uplink metric that is below a threshold value for a first beam used for communication between the UE and the network entity, a second uplink metric of a second beam that exceeds a corresponding uplink metric for the first beam, a third uplink metric of the second beam that exceeds an absolute threshold value associated with the third uplink metric, a predicted metric value of the first beam or the second beam that meets one or more prediction criteria, or a change in an uplink beam pattern.
Aspect 47: The method of any of aspects 44 through 46, wherein the configuration information indicates that one or more instances of a scheduling request that includes the request to update the measurement report are to be transmitted, followed by transmission of one or more instances of a random access channel request that indicates the request to update the measurement report in an absence of a response to the one or more instances of the scheduling request, the scheduling request and the random access channel request use different uplink beams.
Aspect 48: The method of any of aspects 44 through 47, further comprising: obtaining an updated measurement report from the UE in accordance with the request to update the measurement report, wherein an uplink resource and format for the updated measurement report is indicated in the configuration information or is based at least in part on a beam update event of the first set of beam update events that triggered the request to update the measurement report.
Aspect 49: A UE for wireless communications, comprising one or more memories, and one or more processors coupled with the one or more memories and configured to cause the UE to perform a method of any of aspects 1 through 20.
Aspect 50: A UE for wireless communications, comprising at least one means for performing a method of any of aspects 1 through 20.
Aspect 51: A non-transitory computer-readable medium storing code for wireless communications, the code comprising instructions executable by one or more processors to perform a method of any of aspects 1 through 20.
Aspect 52: A UE for wireless communications, comprising one or more memories storing processor-executable code, and one or more processors coupled with the one or more memories and configured to cause the UE to perform a method of any of aspects 21 through 26.
Aspect 53: A UE for wireless communications, comprising at least one means for performing a method of any of aspects 21 through 26.
Aspect 54: A non-transitory computer-readable medium storing code for wireless communications, the code comprising instructions executable by one or more processors to perform a method of any of aspects 21 through 26.
Aspect 55: A network entity for wireless communications, comprising one or more memories storing processor-executable code, and one or more processors coupled with the one or more memories and configured to cause the network entity to perform a method of any of aspects 27 through 43.
Aspect 56: A network entity for wireless communications, comprising at least one means for performing a method of any of aspects 27 through 43.
Aspect 57: A non-transitory computer-readable medium storing code for wireless communications, the code comprising instructions executable by one or more processors to perform a method of any of aspects 27 through 43.
Aspect 58: A network entity for wireless communications, comprising one or more memories storing processor-executable code, and one or more processors coupled with the one or more memories configured to cause the network entity to perform a method of any of aspects 44 through 48.
Aspect 59: A network entity for wireless communications, comprising at least one means for performing a method of any of aspects 44 through 48.
Aspect 60: A non-transitory computer-readable medium storing code for wireless communications, the code comprising instructions executable by one or more processors to perform a method of any of aspects 44 through 48.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers.

Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories; and
one or more processors coupled with the one or more memories and configured to cause the UE to:
receive configuration information that indicates a first set of beam update events that include one or more beam update events associated with one or more uplink conditions to trigger a transmission of a request to update a measurement report associated with a channel between the UE and a network entity, wherein the configuration information further indicates a second set of beam update events that include one or more beam update events associated with one or more downlink conditions to trigger the transmission of the request to update the measurement report; and
transmit the request to update the measurement report in accordance with a detected uplink condition that meets the one or more uplink conditions of the first set of beam update events or a detected downlink condition that meets the one or more downlink conditions of the second set of beam update events.

2. The UE of claim 1, wherein the one or more uplink conditions include one or more of a first uplink metric that is below a threshold value for a first beam used for communication between the UE and the network entity, a second uplink metric of a second beam that exceeds a corresponding uplink metric for the first beam, a third uplink metric of the second beam that exceeds an absolute threshold value associated with the third uplink metric, a predicted metric value of the first beam or the second beam that meets one or more prediction criteria, or a change in an uplink beam pattern.

3. The UE of claim 1, wherein the one or more processors are configured to cause the UE to:
transmit the request to update the measurement report in accordance with the detected uplink condition that meets the one or more uplink conditions and at least a first downlink condition associated with a first beam that meets the one or more downlink conditions.

4. The UE of claim 2, wherein one or more of the first uplink metric, second uplink metric, or third uplink metric include an uplink reference signal received power (RSRP), an uplink signal to interference and noise ratio (SINR), an uplink throughput value, an uplink transmit power, or a maximum permissible exposure (MPE) value.

5. The UE of claim 1, wherein the first set of beam update events include a first subset of beam update events associated with a first transmission-reception point (TRP) or a first component carrier, and a second subset of beam update events associated with a second TRP or a second component carrier.

6. The UE of claim 1, wherein the one or more uplink conditions include a first uplink metric that has a value above or below a first threshold value, and wherein the first threshold value is associated with the first uplink metric and a first event of the first set of beam update events, and the first threshold value is based at least in part on one or more of an indication provided with the configuration information, a defined threshold value, or a capability of the UE.

7. The UE of claim 1, wherein the one or more processors are configured to cause the UE to:
transmit one or more instances of a scheduling request that indicates the request to update the measurement report; and
transmit one or more instances of a random access channel request that indicates the request to update the measurement report in an absence of a response to the one or more instances of the scheduling request, wherein the scheduling request and the random access channel request are transmitted via different uplink beams.

8. The UE of claim 1, wherein the one or more processors are configured to cause the UE to:
transmit one or more instances of a random access channel request that indicates the request to update the measurement report based at least in part on the detected uplink condition is below a threshold value.

9. The UE of claim 1, wherein the request to update the measurement report includes an event indication that indicates a first beam update event of the first set of beam update events associated with the detected uplink condition, or a second beam update event of the second set of beam update events associated with the detected downlink condition.

10. The UE of claim 9, wherein the event indication comprises a set of bits, and different bit values of the set of bits indicate different events or combinations of events of the first set of beam update events and the second set of beam update events.

11. The UE of claim 1, wherein the one or more processors are configured to cause the UE to:
select a first uplink resource for transmission of the request to update the measurement report based at least in part on detection of a beam update event of the first set of beam update events, or select a second uplink resource for transmission of the request to update the measurement report based at least in part on detection of a beam update event of the second set of beam update events.

12. The UE of claim 1, wherein the configuration information further indicates a priority associated with each beam update event of the first set of beam update events and the second set of beam update events.

13. The UE of claim 12, wherein the configuration information indicates separate priority lists for the first set of beam update events and the second set of beam update events.

14. The UE of claim 12, wherein the configuration information indicates a common priority list for beam update events of the first set of beam update events and the second set of beam update events.

15. The UE of claim 1, wherein the one or more processors are configured to cause the UE to:
transmit a plurality of instances of the request to update the measurement report, a quantity of the plurality of instances of the request to update the measurement report based at least in part on a configured quantity or a prohibit timer that is initiated upon transmission of an instance of the request to update the measurement report, wherein the quantity of the plurality of instances of the request to update the measurement report, or a value of the prohibit timer, is based at least in part on a priority associated with each beam update event of the first set of beam update events and the second set of beam update events.

16. The UE of claim 1, wherein the one or more processors are configured to cause the UE to:
receive a resource allocation for transmission of an updated measurement report, wherein the resource allocation indicates first resources for an updated uplink measurement report, second resources for an updated downlink measurement report, or joint resources for an updated joint uplink and downlink measurement report.

17. The UE of claim 1, wherein the one or more processors are configured to cause the UE to:
transmit an updated measurement report to the network entity in accordance with the request to update the measurement report, wherein an uplink resource and format for the updated measurement report is indicated in the configuration information or is based at least in part on a beam update event of the first set of beam update events or the second set of beam update events that triggered the request to update the measurement report.

18. The UE of claim 17, wherein the updated measurement report has a format that includes a first field that indicates a metric associated with a measured reference signal, and a second field that indicates whether the metric is an uplink metric or a downlink metric.

19. A user equipment (UE), comprising:
one or more memories; and
one or more processors coupled with the one or more memories and configured to cause the UE to:
receive configuration information that indicates a first set of beam update events that include one or more beam update events associated with one or more uplink conditions to trigger a transmission of a request to update a measurement report that includes one or more uplink channel metrics associated with a channel between the UE and a network entity; and
transmit the request to update the measurement report in accordance with a detected uplink condition that meets the one or more uplink conditions of the first set of beam update events.

20. The UE of claim 19, wherein:
the one or more uplink conditions are configured separately from one or more downlink conditions associated with one or more downlink channel metrics.

21. The UE of claim 19, wherein the one or more processors are configured to cause the UE to:
transmit one or more instances of a scheduling request that indicates the request to update the measurement report; and
transmit one or more instances of a random access channel request that indicates the request to update the measurement report in an absence of a response to the one or more instances of the scheduling request, wherein the scheduling request and the random access channel request are transmitted via different uplink beams.

22. The UE of claim 19, wherein the one or more processors are configured to cause the UE to:
transmit one or more instances of a random access channel request that indicates the request to update the measurement report based at least in part on the detected uplink condition being below a threshold value.

23. A network entity, comprising:
one or more memories; and
one or more processors coupled with the one or more memories and configured to cause the network entity to:
output configuration information that indicates a first set of beam update events that include one or more beam update events associated with one or more uplink conditions to trigger a request from a user equipment (UE) to update a measurement report associated with a communications channel of the UE, and a second set of beam update events that include one or more beam update events associated with one or more downlink conditions to trigger the request to update the measurement report; and
obtain the request to update the measurement report that indicates a detected uplink condition at the UE meets the one or more uplink conditions of the first set of beam update events or a detected downlink condition at the UE meets the one or more downlink conditions of the second set of beam update events.

24. The network entity of claim 23, wherein the first set of beam update events include a first subset of beam update events associated with a first transmission-reception point (TRP) or a first component carrier, and a second subset of beam update events associated with a second TRP or a second component carrier.

25. The network entity of claim 23, wherein the configuration information indicates that one or more instances of a scheduling request that includes the request to update the measurement report are to be transmitted, followed by transmission of one or more instances of a random access channel request that indicates the request to update the measurement report in an absence of a response to the one or more instances of the scheduling request, wherein the scheduling request and the random access channel request use different uplink beams.

26. A network entity, comprising:
one or more memories; and
one or more processors coupled with the one or more memories and configured to cause the network entity to:
output configuration information that indicates a first set of beam update events that includes one or more beam update events associated with one or more uplink conditions at a user equipment (UE) to trigger a transmission by the UE of a request to update a measurement report that includes one or more uplink channel metrics associated with a communications channel of the UE; and
obtain the request to update the measurement report that indicates a detected uplink condition at the UE meets the one or more uplink conditions of the first set of beam update events.

27. The network entity of claim 26, wherein:
the one or more uplink conditions are configured separately from one or more downlink conditions associated with one or more downlink channel metrics.

28. The network entity of claim 26, wherein the one or more uplink conditions include one or more of a first uplink metric that is below a threshold value for a first beam used for communication between the UE and the network entity, a second uplink metric of a second beam that exceeds a corresponding uplink metric for the first beam, a third uplink metric of the second beam that exceeds an absolute threshold value associated with the third uplink metric, a predicted metric value of the first beam or the second beam that meets one or more prediction criteria, or a change in an uplink beam pattern.

29. The network entity of claim 26, wherein the configuration information indicates that one or more instances of a scheduling request that includes the request to update the measurement report are to be transmitted, followed by transmission of one or more instances of a random access channel request that indicates the request to update the measurement report in an absence of a response to the one or more instances of the scheduling request, wherein the scheduling request and the random access channel request use different uplink beams.

30. The network entity of claim 26, wherein the one or more processors are configured to cause the network entity to:
obtain an updated measurement report from the UE in accordance with the request to update the measurement report, wherein an uplink resource and format for the updated measurement report is indicated in the configuration information or is based at least in part on a beam update event of the first set of beam update events that triggered the request to update the measurement report.
